(19) United States
(12) Patent Application Publication
(10) Pub. No.: US 2014/0160505 A1
(43) Pub. Date: Jun. 12, 2014

(54) IMAGE PROCESSING APPARATUS, METHOD OF CONTROLLING IMAGE PROCESSING APPARATUS, AND PROGRAM

(71) Applicant: CANON KABUSHIKI KAISHA, Tokyo (JP)

(72) Inventors: Tomohiro Tachikawa, Tokyo (JP); Naotsugu Itoh, Kawasaki-shi (JP)

(21) Appl. No.: 14/092,186

(22) Filed: Nov. 27, 2013

(30) Foreign Application Priority Data
Dec. 3, 2012 (JP) 2012-264254
Dec. 3, 2012 (JP) 2012-264536

(51) Int. Cl. H04N 1/00; G06K 15/00

(52) U.S. Cl. CPC H04N 1/00891; G06K 15/4055
USPC 358/1.13

(57) ABSTRACT

An image processing apparatus having a first electric power state and a second electric power state in which less electric power is consumed than in the first electric power state, includes a detection unit including a plurality of detector elements capable of detecting an object, a registration unit configured to register a detector element in the plurality of the detector elements as an invalid detector element that is to be neglected, and an electric power control unit configured to turn the image processing apparatus into the first electric power state or the second electric power state according to a detection state of a detector element other than the detector element registered as the invalid detector element by the registration unit.

### BACKGROUND OF THE INVENTION

1. Field of the Invention

The present invention relates to a technique to control an image processing apparatus such that in response to detecting an approaching object (for example, a human operator) by a detector, a state of the image processing apparatus is returned into a normal state from a power saving state.

2. Description of the Related Art

According to a related technique, it is known to configure an image processing apparatus such that when no operation is performed for a particular period, the state of the image processing apparatus is switched into a power saving state. However, it takes a particular time to return into a normal state from the power saving state, which may impair convenience of users.

To handle the above situation, it has been proposed to detect a person approaching the image processing apparatus, and return the state of the image processing apparatus into the normal state from the power saving state (for example, see Japanese Patent Laid-Open No. 2012-177796).

However, in the apparatus disclosed in Japanese Patent Laid-Open No. 2012-177796, for example, in a case where a desk for a certain person is located in a peripheral of an area monitored by a person detector, the person at the desk may be always detected by the person detector, which may cause the state of the image processing apparatus to be returned into the normal state from the power saving state or may make it difficult to switch into the power saving state.

Another method to handle the above situation may be to reduce the sensitivity of the person detector such that a person is detected in a smaller detection range. However, in this technique, a true user is detected only after he/she enters the reduced detection range, and thus there is a possibility that the operation of returning into the normal state is still in process when the true user reaches the image processing apparatus, which may impair the convenience of the true user.

### SUMMARY OF THE INVENTION

In view of the above, the present invention relates to a technique to solve the above-described situation. More specifically, the invention provides a technique to properly control an image processing apparatus configured to detect presence of an object and return into a normal state from a power saving state in response to the detection such that the image processing apparatus is properly maintained in the power saving state without being unnecessarily returned into the normal state even in an installation environment in which an object approaching with no intention of using the image processing apparatus is frequently detected.

According to an aspect of the present invention, an image processing apparatus having a first electric power state and a second electric power state in which less electric power is consumed than in the first electric power state, includes a detection unit including a plurality of detector elements capable of detecting an object, a registration unit configured to register a detector element in the plurality of the detector elements as an invalid detector element that is to be neglected, and an electric power control unit configured to turn the image processing apparatus into the first electric power state or the second electric power state according to a detection state of a detector element other than the detector element registered as the invalid detector element by the registration unit.

Further features of the present invention will become apparent from the following description of exemplary embodiments with reference to the attached drawings.

### BRIEF DESCRIPTION OF THE DRAWINGS

FIG. 1 is a block diagram illustrating an example of a configuration of an image processing apparatus according to an embodiment of the invention.

FIG. 2 is a diagram illustrating a positional relationship between an image processing apparatus and a detection area covered by a detection unit as seen from a side of the image processing apparatus.

FIG. 3 is a diagram illustrating a positional relationship between an image processing apparatus and a detection area covered by a detection unit as seen from above the image processing apparatus.

FIG. 4 is a diagram illustrating a result of a detection performed by a detection unit in a situation in which there is a person at a desk in a detection area.

FIG. 5 is a diagram illustrating an example of an invalid area list which is a list of areas specified as invalid areas included in a whole detection area of a detection unit such that detection of a person in any of these invalid areas is neglected and returning into the normal state from the power saving state is not performed.

FIGS. 6A and 6B are diagrams illustrating examples of screens displayed on an operation panel.

FIG. 7 is a flow chart illustrating an example of a process of, in response to a detection, returning into a normal state or adding an area to an invalid area list according to an embodiment.

FIG. 8 is a flow chart illustrating an example of a process of adding or deleting an invalid area on an operation panel according to an embodiment.

FIG. 9A-9B is a diagram illustrating an example of an external appearance of an image processing apparatus.

FIG. 10 is a block diagram illustrating an example of the configuration of an image processing apparatus representing electronic equipment according to an embodiment of the present invention.

FIG. 11 is a block diagram of an example of the configuration of a terminal apparatus.

FIGS. 12A, 12C, and 12E are diagrams each illustrating the positional relationship between an image processing apparatus and surrounding user(s), and FIGS. 12B, 12D, and 12F are schematic diagrams each illustrating the detection range of a human presence sensor unit.

FIGS. 13A to 13F are diagrams each illustrating an example of a screen displayed on a display/operation unit when a remote operation is performed on the image processing apparatus using the terminal apparatus.

FIGS. 14A to 14C are diagrams each illustrating an example of a screen displayed on the display/operation unit when a remote operation is performed on the image processing apparatus using the terminal apparatus.

FIG. 15 is a diagram illustrating a flowchart of the image processing apparatus on a human presence sensor screen.

FIG. 16 is a diagram illustrating a flowchart of the image processing apparatus on a setting change screen.

### DESCRIPTION OF THE EMBODIMENTS

The present invention is described below with reference to embodiments in conjunction with drawings.

### First Embodiment

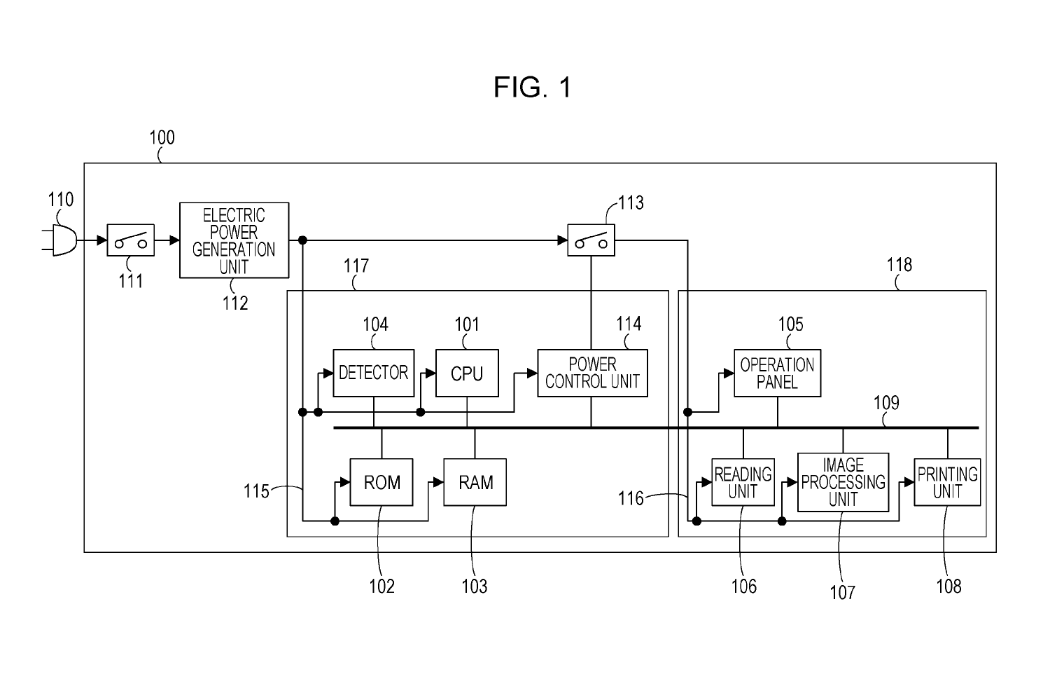

FIG. 1 is a block diagram illustrating an example of a configuration of an image processing apparatus according to a first embodiment. In FIG. 1, reference numeral 100 denotes an image processing apparatus (hereinafter also referred to as a multifunction peripheral (MFP)) according to the present embodiment. Reference numeral 101 denotes a central processing unit (CPU) that controls an electric power supply according to the present embodiment. Reference numeral 102 denotes a read only memory (ROM) in which a program and/or data used by the CPU 101 are stored. The ROM 102 may be a flash ROM rewritable by the CPU 101. Reference numeral 103 denotes a random access memory (RAM) used by the CPU 101 in executing the program.

Reference numeral 104 denotes a detection unit. A specific example of the detection unit 104 is a pyroelectric array sensor. The detection unit 104 is used to detect presence of an object such that a total detection area is divided into subareas and detecting of presence of an object is performed individually for each subarea. Hereinafter, each subarea in the total detection area will be referred to simply as a detection area unless no confusion occurs. Objects to be detected by the detection unit 104 may be stationary objects or moving objects. Although in the present embodiment, it is assumed that objects to be detected by the detection unit 104 are persons, the objects to be detected by the detection unit 104 are not limited to persons. In the present embodiment, the detection unit 104 is configured to detect presence of a person based on, for example, the amount of infrared radiation detected in each subarea defined as a detection area. The CPU 101 is capable of acquiring, from the detection unit 104, area position information indicating the position of a detection area in which a person is detected by the detection unit 104. Note that the pyroelectric array sensor is a sensor of a type including pyroelectric sensors arranged in an N×N array (in the present embodiment, it is assumed by way of example that pyroelectric sensors are arranged in a 7×7 array). The pyroelectric sensor is a passive sensor capable of detecting an approaching person based on a change in temperature of infrared radiation naturally radiated from an object such as a human body. The pyroelectric sensor has a feature that it is capable of detecting an object over a relatively large detection area with small power consumption.

Reference numeral 105 denotes an operation panel configured to accept an operation on the image processing apparatus 100 and display information including a status of the image processing apparatus 100.

Reference numeral 106 denotes a reading unit configured to read a document and generate image data thereof. Reference numeral 107 denotes an image processing unit configured to perform image processing on image data generated by the reading unit 106 and input to the image processing unit 107 via the RAM 103. Reference numeral 108 denotes a printing unit configured to print on a paper medium or the like according to the image data subjected to the image processing by the image processing unit 107 and then input to the printing unit 108 via the RAM 103.

Reference numeral 110 denotes a power plug. Reference numeral 111 denotes a main switch for use by a user to physically turn on or off the electric power of the image processing apparatus 100. Reference numeral 112 denotes an electric power generation unit configured to generate, from a power supply voltage supplied from the power plug 110, electric power to be supplied to the CPU 101 and other units.

Reference numeral 115 denotes an electric power line for always supplying the electric power generated by the electric power generation unit 112 as long as the main switch 111 is in an on-state. Reference numeral 117 denotes a first-power-supplied group to which electric power is always supplied via the electric power line 115.

Reference numeral 113 denotes an electric power control element (such as a field effect transistor (FET)) capable of electronically turning on and off the electric power. Reference numeral 114 denotes a power control unit configured to generate a signal by which to turn on and off the electric power control element 113.

Reference numeral 116 denotes an output electric power line extending from the electric power control element 113 and connected to the operation panel 105, the reading unit 106, the image processing unit 107, and the printing unit 108. Reference numeral 118 denotes a second-power-supplied group to which electric power is supplied from the electric power control element 113 via the output electric power line 116.

Reference numeral 109 denotes a bus that connects, to each other, the CPU 101, the ROM 102, the RAM 103, the detection unit 104, the operation unit 105, the reading unit 106, the image processing unit 107, the printing unit 108, and the power control unit 114.

In the present embodiment, the CPU 101 controls the electric power control element 113 via the power control unit 114 such that supplying of electric power to the output electric power line (on-demand electric power line) 116 is stopped to turn off the electric power to the second-power-supplied group 118 thereby reducing the electric power consumed by the image processing apparatus 100. Hereinafter, when electric power is supplied only to the first-power-supplied group 117, this state of the image processing unit 100 is referred to as a “power saving state” (in this state, it is not allowed to perform the image processing operation). The operation of switching into this state by the CPU 101 refers to as “switching into the power saving state.”

The CPU 101 also controls the electric power control element 113 via the power control unit 114 such that electric power is supplied to the output electric power line 116 to activate the units such as the operation unit 105 included in the second-power-supplied group 118. Hereinafter, when electric power is supplied to both the first-power-supplied group 117 and the second-power-supplied group 118, this state of the image processing unit 100 is referred to as a “normal state” (in this state, it is allowed to perform the image processing operation). The operation of switching into this state by the CPU 101 refers to as “switching into the normal state”, or “returning into the normal state”. Note that it is allowed to perform the image processing operation in the normal state.

Even in the power saving state, some units such as the RAM 103 and the CPU 101 in the first-power-supplied group 117 may be switched into the power saving mode. In the case of the RAM 103, the RAM 103 may be in a self refreshing mode in which power consumption is reduced.

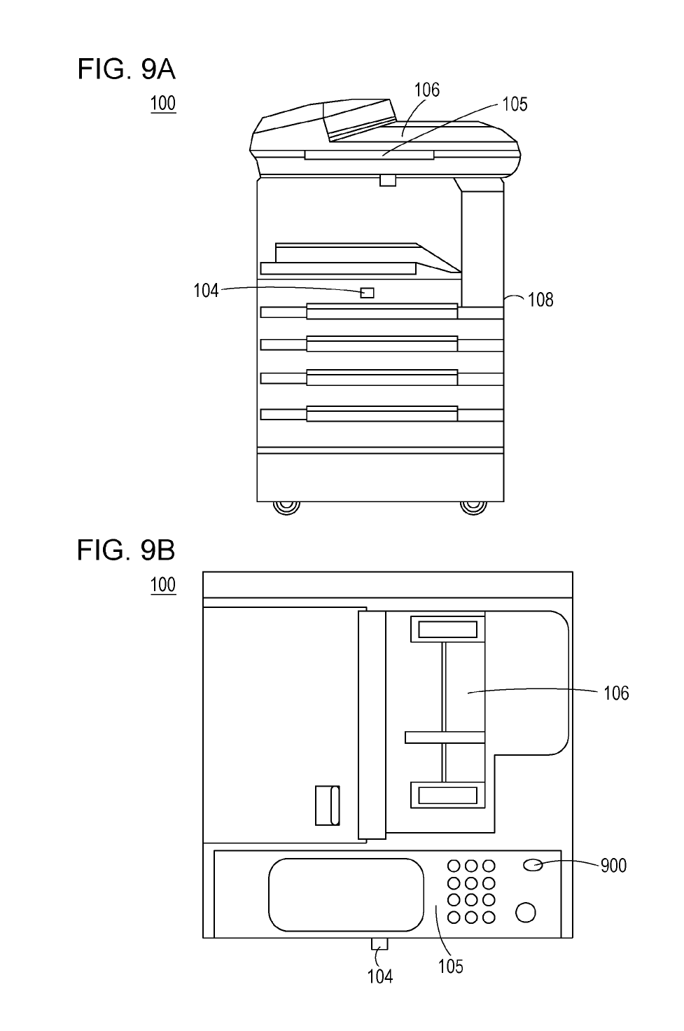

FIGS. 9A and 9B are diagrams illustrating an example of an external appearance of the image processing unit 100. In FIGS. 9A and 9B, similar elements to those in FIG. 1 are denoted by similar reference numerals.

FIG. 9A is a front view of the image processing unit 100, and FIG. 9B is a top view of the image processing unit 100.

Reference numeral 900 denotes a return switch for use by a user to issue a command to return the state into the normal state from the power saving state.

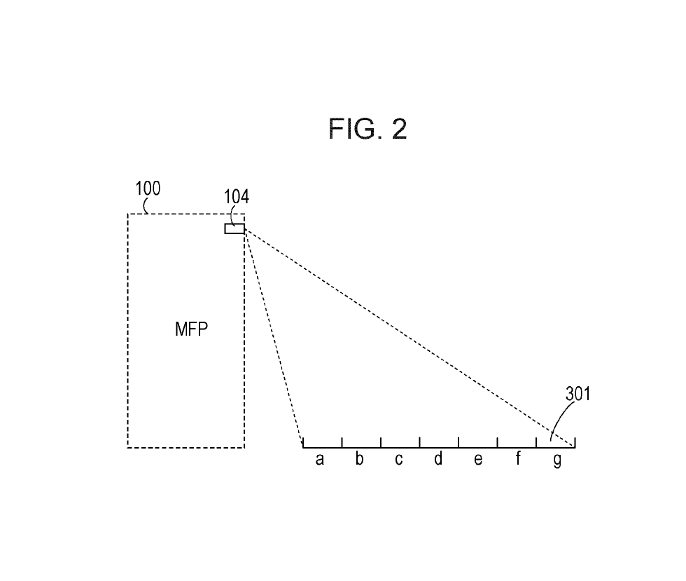

FIG. 2 is a diagram illustrating a positional relationship seen from the side of the image processing apparatus 100 between the image processing apparatus 100 and the detection area covered by the detection unit 104. In FIG. 2, elements similar to those in FIG. 1 are denoted by similar reference numerals.

In FIG. 2, reference numeral 301 denotes a detection area detectable by the detection unit 104 pointed in a forward and downward direction from the image processing apparatus 100.

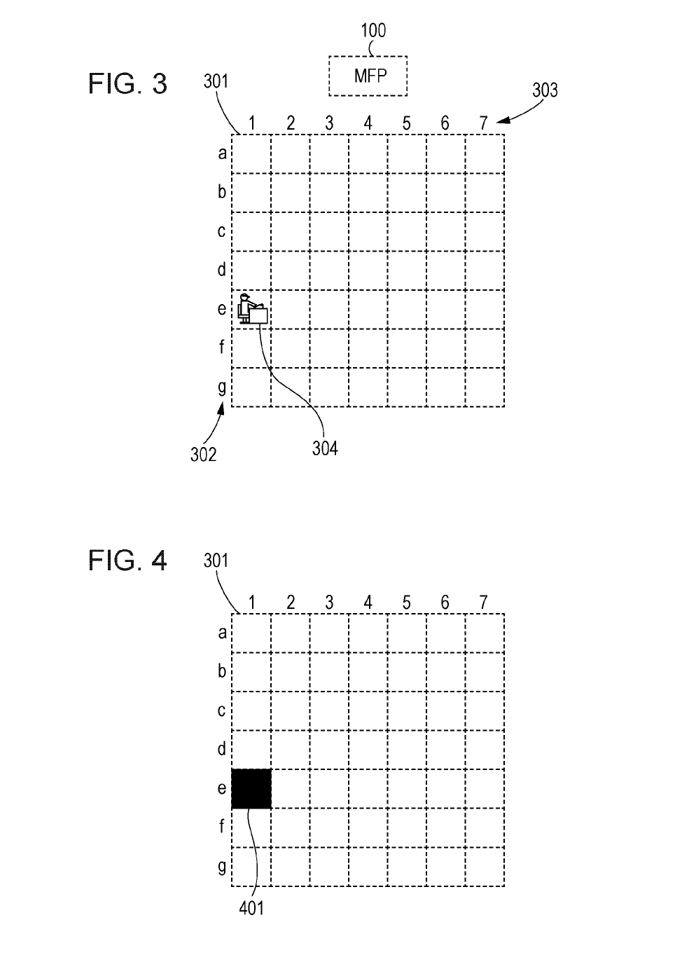

FIG. 3 is a diagram illustrating a positional relationship seen from above the image processing apparatus 100 between the image processing apparatus 100 and the detection area 301. Note that elements similar to those in FIG. 2 are denoted by similar reference numerals.

In the present embodiment, a pyroelectric array sensor including pyroelectric sensors arranged in a 7×7 array is used as the detection unit 104. 7×7 squares 301 in the total detection area in FIG. 3 are detection areas which are individually detectable by the detection unit 104. The detection areas correspond in a one-to-one manner to the pyroelectric sensors in the pyroelectric sensor array such that it is possible to identify a detection area in which a person is detected based on which one of the pyroelectric sensors in the array detects the person.

To identify each detection area position, rows 302 of the array of squares in the total detection area are respectively referred to as a, b, c, d, e, f, and g in the order from the row closest to the image processing apparatus 100 to the row farthest away.

Columns 303 of the array of squares in the total detection area are respectively referred to as 1, 2, 3, 4, 5, 6, and 7 in the order from the left to the right in front of the image processing apparatus 100.

Hereinafter in the description of the present embodiment, when seen from the front of the image processing apparatus 100, the detection area at the leftmost location in the row closest to the image processing apparatus 100 is denoted as a1, the detection area at the right most location in this row is denoted as a7, and so on.

In the first embodiment, it is assumed by way of example that a desk is located in a detection area denoted by reference numeral 304.

FIG. 4 illustrates a result of detection performed by the detection unit 104 in a situation in which a person is present at the desk 304 illustrated in FIG. 3.

In FIG. 4, a solid square 401 denotes a detection area in which presence of the person is detected by the detection unit 104. In this specific example illustrated in FIG. 4, the detection unit 104 outputs data indicating e1 as area position information.

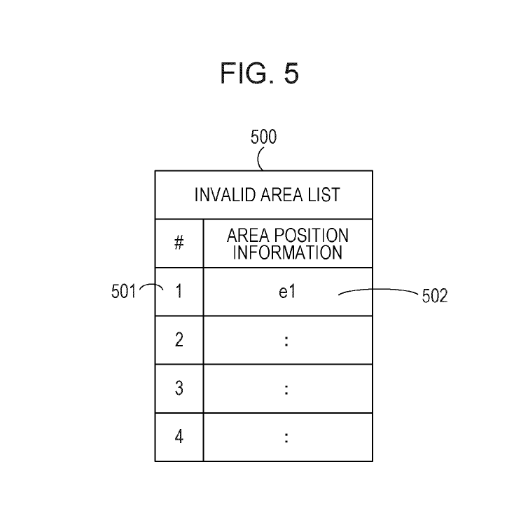

FIG. 5 illustrates a list of areas specified as invalid areas in the total area in FIG. 3 covered by the detection unit 104 such that detection of a person in any of these invalid areas is neglected and returning into the normal state from the power saving state is not performed.

In FIG. 5, reference numeral 500 denotes the invalid area list defining areas specified as invalid areas. The invalid area list 500 is stored in the ROM 102 and read and written by the CPU 101. Reference numeral 501 denotes a serial number, and reference numeral 502 denotes area position information.

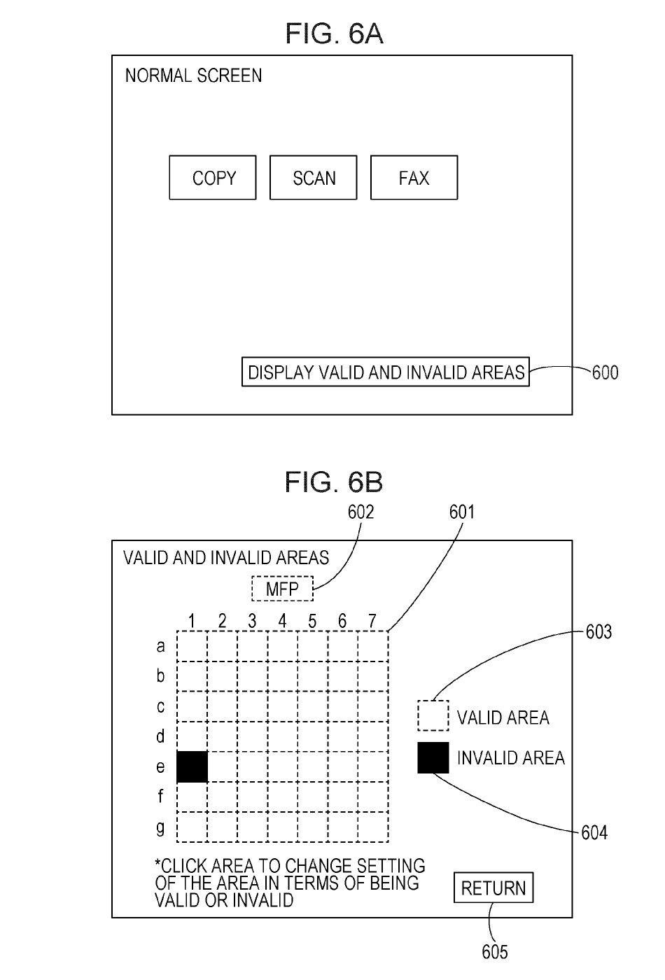

FIGS. 6A and 6B are diagrams illustrating examples of screens displayed on the operation panel 105.

More specifically, FIG. 6A illustrates a normal screen displayed on the operation panel 105.

In FIG. 6A, a “display valid and invalid areas” key. If this key is clicked, a valid/invalid area screen (FIG. 6B) is opened and a user is allowed on this screen to specify one or more invalid areas in the detection area covered by the detection unit 104.

FIG. 6B illustrates a screen on which valid/invalid areas are displayed.

In FIG. 6B, reference numeral denotes area state display/change keys. Each of these keys has two functions, one of which is to display a current state of the key assigned to one of detection areas detected by the detection units 104 as to whether the detection area is specified as a valid or invalid area. The other function is to specify or change the state of the detection area corresponding to the key as to whether the detection area is valid or invalid.

Reference numeral 602 denotes a location of the image processing apparatus 100. The relative position of each detection area is clearly defined with respect to the image processing apparatus 100.

Reference numeral 603 illustrates a manner of displaying an area state display/change key when a corresponding detection area is specified as valid, while reference numeral 604 illustrates a manner of displaying an area state display/change key when a corresponding detection area is specified as in valid.

Reference numeral 605 denotes a return key used to close the valid/invalid area valid/invalid area display screen illustrated in FIG. 6B and reopen the normal screen illustrated in FIG. 6A.

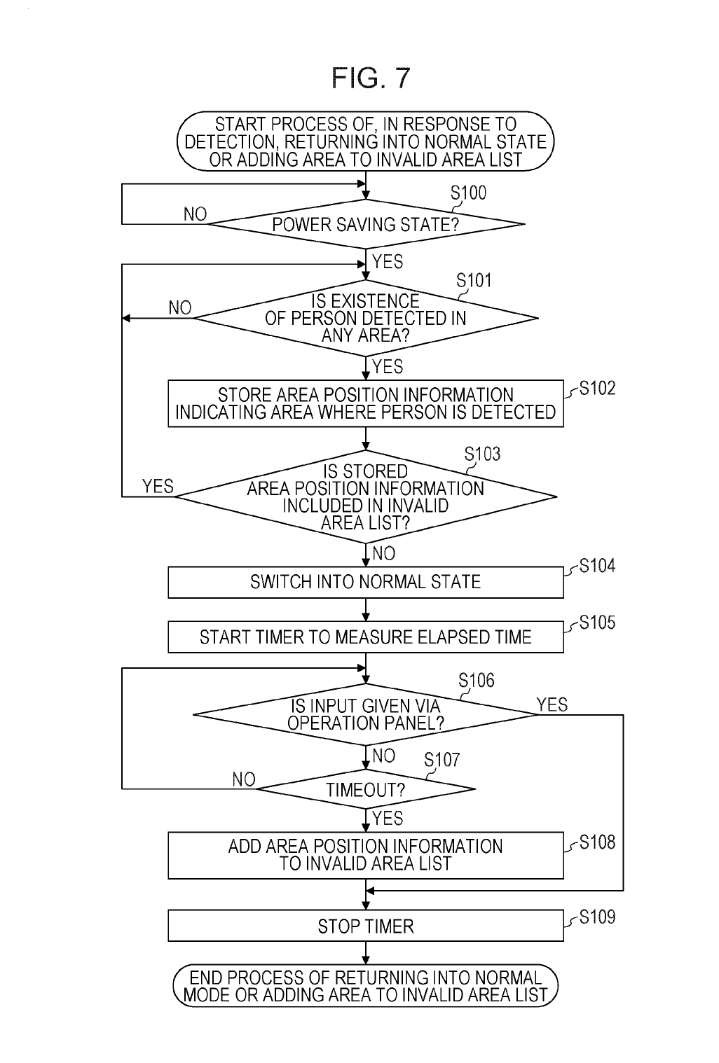

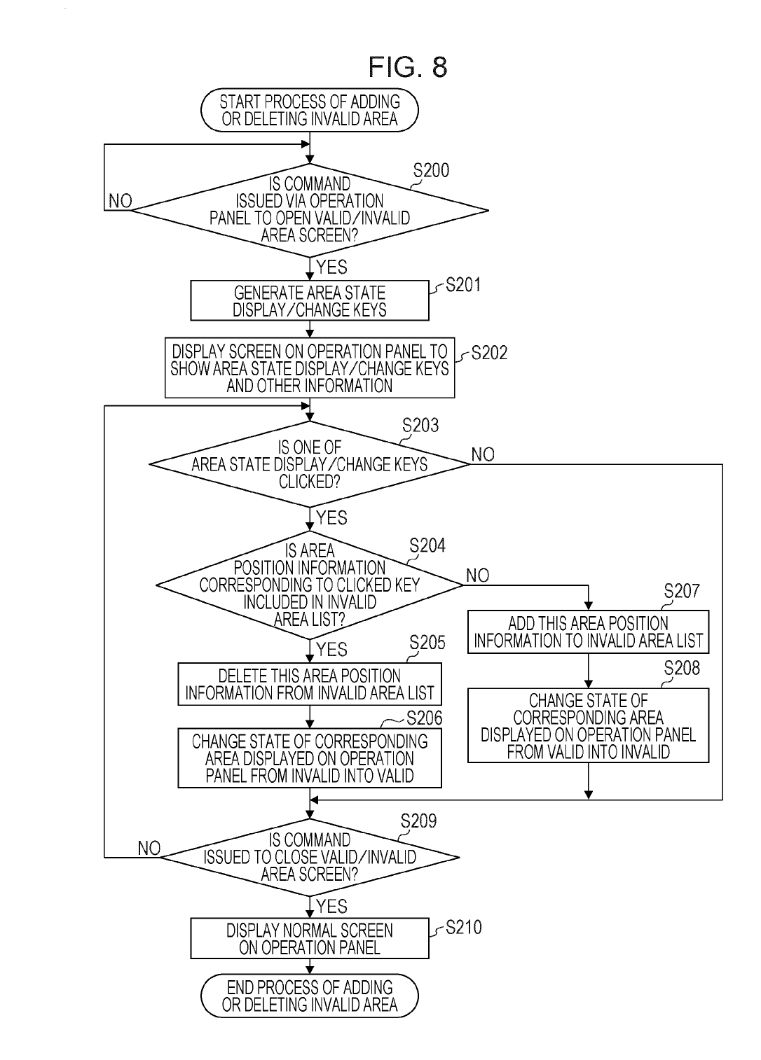

Next, referring to FIG. 7 and FIG. 8, an explanation is given below as to processes according to the present embodiment, including a process of detecting a user approaching the image processing apparatus 100, a process of switching between the power saving state and the normal state, a process of registering an invalid area. Process of returning into normal state or adding invalid area in response to detection

First, a flow of a process according to the present embodiment is described below with reference to a flow chart illustrated in FIG. 7.

FIG. 7 is flow chart illustrating an example of a process of returning into the normal state or adding an invalid area in response to detection. The process illustrated in this flow chart is realized by the CPU 101 by executing a program stored in a computer-readable manner in the ROM 102.

First, the CPU 101 determines whether the image processing apparatus 100 is in the power saving state (S100).

In a case where it is determined in S100 that the image processing apparatus 100 is not in the power saving state (the answer to S100 is No), the CPU 101 repeats the process in S100.

On the other hand, in a case where it is determined in S100 that the image processing apparatus 100 is in the power saving state (the answer to S100 is Yes), the CPU 101 advances the processing flow to S101.

In S101, the CPU 101 determines whether the detection unit 104 detects presence of a person in one of detection areas a1 to g7 in the detection area 301 (FIG. 3).

In a case where it is determined in S101 that no person is detected in any detection area (the answer to S101 is No), the CPU 101 repeats the process in S101. On the other hand, in a case where it is determined in S101 that presence of a person is detected in one of detection areas, for example, in a case where a person at the desk 304 illustrated in FIG. 3 is detected in a detection area e1 (the answer to S101 is Yes), the CPU 101 advances the processing flow to S102.

In S102, the CPU 101 stores, in the RAM 103, the area position information indicating the detection area (for example, the detection area e1 in this specific example) where the presence of the person is detected in S101, and the CPU 101 advances the processing flow to S103. For example, in the present case in which the detection result is as illustrated in FIG. 4, “e1” is stored in S102 as the detection area information.

In S103, the CPU 101 determines whether the area position information stored in S102 is included in the invalid area list 500.

In a case where the determination performed in S103 is that the area position information stored in S102 is included in the invalid area list 500 (the answer to S103 is Yes), the CPU 101 neglects the detection result, and returns the processing flow to S101.

On the other hand, in a case where the determination performed in S103 is that the area position information stored in S102 is not included in the invalid area list 500 (the answer to S103 is No), the CPU 101 advances the processing flow to S104.

In S104, the CPU 101 performs a switching process (return-from-sleep process) to switch the state from the power saving state into the normal state, and then the CPU 101 advances the processing flow to S105.

In S105, the CPU 101 starts a timer (time measurement timer) to measure an elapsed time. The CPU 101 then advances the processing flow to S106.

In S106, the CPU 101 determines where an input is given via the operation panel 105.

In a case where it is determined in S106 that an input is given via the operation panel 105 (the answer to S106 is Yes), the CPU 101 directly advances the processing flow to S109.

On the other hand, in a case where it is determined in S106 that no input is given via the operation panel 105 (the answer to S106 is No), the CPU 101 advances the processing flow to S107.

In S107, the CPU 101 determines whether the time measured by the time measurement timer has reached a predetermined value set in advance via the operation panel 105.

In a case where it is determined in S107 that the predetermined time has not yet elapsed (the answer to S107 is No), the CPU 101 returns the processing flow to S106.

On the other hand, in a case where it is determined in S107 that the predetermined time has elapsed (the answer to S107 is Yes), the CPU 101 advances the processing flow to S108. Note that the time may reach the predetermined value when no input is given via the operation panel 105 while the time measurement timer is measuring the time starting immediately after the state is switched into the normal state.

In S108, the CPU 101 adds the area position information stored in S102 to the invalid area list 500 (FIG. 5), and the CPU 101 advances the processing flow to S109.

In S109, the CPU 101 stops the time measurement timer, and ends the process of returning into the normal state or adding an invalid area.

The process described above allows the image processing apparatus 100 to detect a user approaching the image processing apparatus 100 and switch the state into the normal state from the power saving state. Furthermore, registration of an invalid area to be neglected, such as an area in which there is a desk for a person, is performed automatically without needing a manual operation by a user.

In the present embodiment, if an event occurs even only once in which no input is given via the operation panel after a person is detected in a particular detection area, this particular detection area is set as an invalid area such that detection of an object in this invalid area is neglected and the power saving state is maintained. Alternatively, setting a particular detection area as an invalid area which is to be neglected without returning into the normal state from the power saving state may be performed when presence of a person in this particular detection area is detected a predetermined number of times or more without detecting a following inputting operation on the operation panel (or when such an event has occurred at a rate equal to or greater value).

On the other hand, in a case where the image processing apparatus 100 has, a predetermined number of times or more (or at a rate greater than a predetermined value), an event in which after a person is detected in a particular detection area registered in the invalid area list 500 (FIG. 5), the return switch 900 (FIG. 9B) on the operation panel unit 105 is pressed within a predetermined time period and, in response to this, the state of the image processing apparatus 100 is returned into the normal state, the CPU 101 may delete the area position information corresponding to the above-described particular detection area from the invalid area list 500.

### Process of Adding or Deleting Invalid Area on Operation Panel

Next, referring to a flow chart illustrated in FIG. 8, an explanation is given below as to a process of displaying valid/invalid areas for respective areas detected by the detection unit 104 according to the invalid area list 500, changing the valid/invalid state of a particular detection area, and updating the invalid area list.

FIG. 8 is a flow chart illustrating an example of a process of adding/deleting an invalid area on the operation panel according to the present embodiment. The process illustrated in this flow chart is realized by the CPU 101 by executing a program stored in a computer-readable manner in the ROM 102.

First, the CPU 101 determines whether a command to display valid and invalid areas is issued via the operation panel 105. More specifically, the determination is performed by checking whether the “valid and invalid area display” key 600 on the normal screen illustrated in FIG. 6A on the operation panel (S200).

In a case where it is determined in S200 that the command to display valid and invalid areas is not issued via the operation panel 105 (the answer to S200 is No), the CPU 101 repeats the process in S200.

On the other hand, in a case where it is determined in S200 that the command to display valid and invalid areas is issued via the operation panel 105 (the answer to S200 is Yes), the CPU 101 advances the processing flow to S201.

In S201, the CPU 101 generates area state display/change keys 601 each indicating whether a corresponding one of detection areas such as those illustrated in FIG. 6B is valid or invalid. More specifically, among detection areas (a1, a2, a3, . . . , g5, g6, g7) illustrated in FIG. 3, detection areas corresponding to area position information registered in the invalid area list 500 are determined as being invalid and these detection areas are displayed as invalid areas 604. More specifically, in the example illustrated in FIG. 5, “e1” is registered as area position information in the invalid area list 500, and thus the detection area “e1” of the area state display/change keys 601 is represented by a solid square in a manner as denoted by 604 to indicate that it is an invalid area. Detection areas that are not registered in the invalid area list 500 are determined as being valid detection areas, and they are displayed by open squares in a manner as denoted by 603 in FIG. 6B.

Next, in S202, the CPU 101 displays the valid/invalid area screen such as that illustrated in FIG. 6B on the operation panel 105 such that the screen includes the area state display/change keys 601 generated in S201. The CPU 101 then advances the processing flow to S203.

In S203, the CPU 101 determines whether any one of the area state display/change keys 601 is pressed.

In a case where it is determined S203 that any one of the area state display/change keys 601 is not pressed (the answer to S203 is No), the CPU 101 directly advances the processing flow to S209.

On the other hand, in a case where it is determined in S203 that one of the area state display/change keys 601 is pressed (the answer to S203 is Yes), the CPU 101 advances the processing flow to S204.

In S204, the CPU 101 determines whether area position information corresponding to the pressed key of the area state display/change keys 601 is included in the invalid area list.

In a case where it is determined in S204 that the area position information corresponding to the pressed key of the area state display/change keys 601 is included in the invalid area list (the answer to S204 is Yes), the CPU 101 determines that the area corresponding to the pressed key is currently specified as an invalid area and thus the CPU 101 advances the processing flow to S205 to change the state of this area into the valid state.

In S205, the CPU 101 deletes the area position information corresponding to the pressed key of the area state display/change keys 601 from the invalid area list. In S206, the CPU 101 changes the state of the pressed key of the area state display/change keys 601 into the valid state in the manner as denoted by 603. The CPU 101 then advances the processing flow to S209.

On the other hand, in a case where it is determined in S204 that the area position information corresponding to the pressed key of the area state display/change keys 601 is not included in the invalid area list (the answer to S204 is No), the CPU 101 determines that the area corresponding to the pressed key is not currently specified as an invalid area and thus the CPU 101 advances the processing flow to S207 to change the state of this area into the invalid state.

In S207, the CPU 101 adds, to the invalid area list, the area position information corresponding to the pressed one of the area state display/change keys 601. In S208, the CPU 101 changes the state of the pressed key of the area state display/change keys 601 into the invalid state in the manner as denoted by 604, and the CPU 101 advances the processing flow to S209.

In S209, the CPU 101 determines whether a command to close the valid/invalid area display screen is issued. More specifically, the determination as to whether the command to close the valid/invalid area display screen is issued is performed by determining whether the return button 605 illustrated in FIG. 6B is pressed.

In a case where it is determined in S209 that the command to close the valid/invalid area display screen is not issued (the answer to S209 is No), the CPU 101 returns the processing flow to S203.

On the other hand, in a case where it is determined in S209 that the command to close the valid/invalid area display screen is issued (the answer to S209 is Yes), the CPU 101 advances the processing flow to S210.

In S210, the CPU 101 displays the normal screen such as that illustrated in FIG. 6A on the operation panel 105 and ends the process of adding/deleting invalid areas on the operation panel.

As described above, a user is allowed to set valid/invalid areas. Furthermore, it is allowed to reset an invalid area into a valid area as required.

When any detection area is manually changed from the invalid state into the valid state, this area may be registered in the ROM 102 and this area may be treated such that it is not allowed to register this area as an invalid area in the following process in FIG. 7.

In the present embodiment, as described above, part of the whole detection area is allowed to be set as an invalid area such that the detection unit neglects the part set as the invalid area in detecting presence of a person, thereby making it possible to control maintain the image processing apparatus so as to be properly maintained in the power saving state without being unnecessarily returned into the normal state from the power saving state even in an installation environment in which the detection area includes a desk, a passage, or the like where a non-user person is supposed to be detected frequently.

In the examples described above, it is assumed that the CPU 101, the ROM 102, and the RAM 103 are disposed in the first-power-supplied group 117. Alternatively, these elements may be disposed in the second-power-supplied group 118, and a subprocessor that consumes less electric power than the CPU 101, the ROM 102, and the RAM 103 may be disposed in the first-power-supplied group 117. In this case, the process in S101 to S104 illustrated in FIG. 7 may be performed by the subprocessor. This allows a further reduction in power consumption in the power saving state, that is, it becomes possible to further save power.

As described above, it is possible to control the image processing apparatus so as to properly maintained in the power saving state without being unnecessarily returned into the normal state from the power saving state even in an installation environment in which the detection area includes a desk, a passage, or the like where a non-user person is supposed to be detected frequently.

Thus, it becomes possible to control electric power such that the state of the image processing apparatus is returned from the power saving state into the normal state in response to detecting a user approaching the image processing apparatus with the intention of using it, while preventing the image processing apparatus from being returned into the normal state from the power saving state in response to detecting a person approaching with no intention of using it.

Note that the structures and the contents of various kinds of data described above are not limited to those employed in the examples, but various other structures and contents may be allowed depending on usage or purposes thereof.

Although the invention has been described above with reference to specific embodiments, the invention may also be practiced in other various embodiments related to, for example, systems, apparatuses, methods, programs, storage media, or the like. More specifically, the invention may be applied to a system including a plurality of devices or to an apparatus including only a single device.

Note that any combination of arbitrary embodiments also falls within the scope of the present invention.

### Second Embodiment

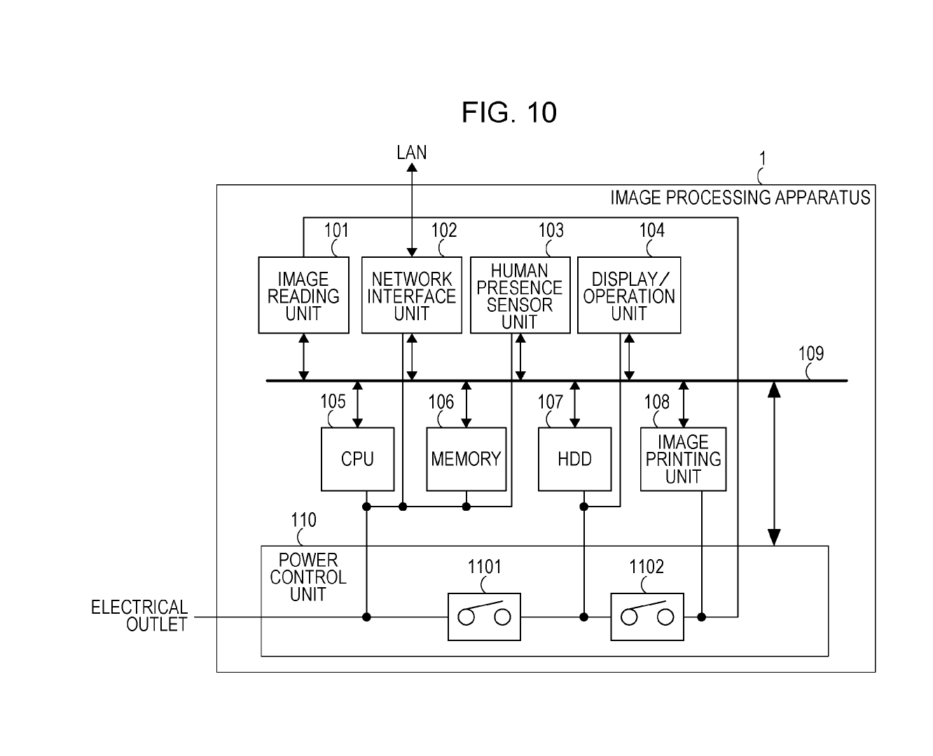

FIG. 10 is a block diagram illustrating an example of the configuration of an image processing apparatus representing electronic equipment according to a second embodiment of the present invention.

As illustrated in FIG. 10, an image processing apparatus 1 includes an image reading unit 101, a network interface unit 102, a human presence sensor unit 103, a display/operation unit 104, a control processing unit (CPU) 105, a memory 106, a hard disk drive (HDD) 107, an image printing unit 108, a data bus 109, and a power control unit 110.

The image reading unit 101 operates under the control of the CPU 105, generates image data by scanning a document set by a user on a platen which is not illustrated, and transmits the image data to the memory 106 via the data bus 109.

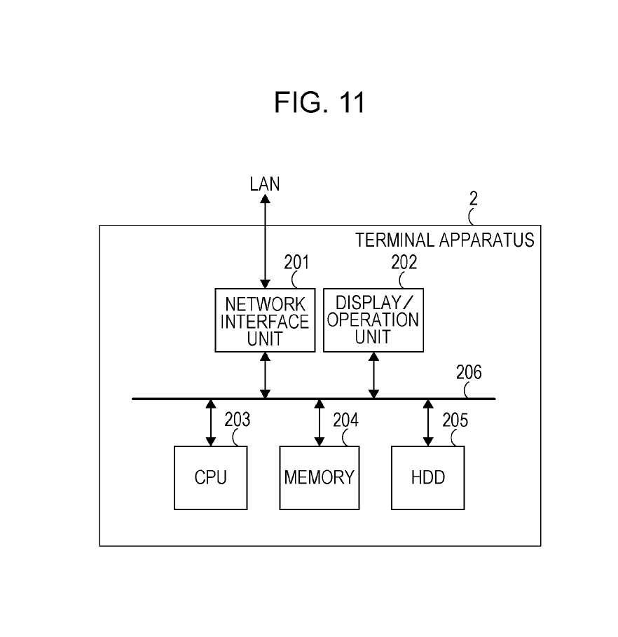

The network interface unit 102 operates under the control of the CPU 105, reads data stored in the memory 106 via the data bus 109, and transmits the data to a local area network (LAN), which is an external component of the image processing apparatus 1. Furthermore, the network interface unit 102 stores the data received from the external component of the image processing apparatus 1; LAN, in the memory 106 via the data bus 109. For example, the image processing apparatus 1 is capable of communicating with a terminal apparatus 2 illustrated in FIG. 11 which will be described later, via the network interface unit 102.

The human presence sensor unit 103 includes a plurality of sensors (human presence sensors) represented by pyroelectric sensors, for detecting an object around the image processing apparatus 1. An object detected by the human presence sensor unit 103 may be a moving object or a stationary object. In this embodiment, an object detected by the human presence sensor unit 103 is described as a human body. However, an object detected by the human presence sensor unit 103 is not necessarily a human body. In this embodiment, the human presence sensor unit 103 includes a plurality of human presence sensors represented by pyroelectric sensors, for detecting a user around the image processing apparatus 1. The human presence sensor unit 103, under the control of the CPU 105, transmits detected information of each human presence sensor to the CPU 105. That is, from the human presence sensor unit 103, the CPU 105 is capable of obtaining detection results of regions corresponding to the plurality of sensors the human presence sensor unit 103 is provided with. Furthermore, the human presence sensor unit 103, under the control of the CPU 105, is capable of changing the detection ranges by changing the directions of the human presence sensors by driving a driving unit, which is not illustrated.

The pyroelectric sensors are capable of detecting the presence of an object by the amount of infrared rays or the like. The pyroelectric sensors are human presence sensors of a passive type, and are used to detect the approach of an object (such as the human body) by detecting a temperature change caused by infrared rays that are emitted naturally from an object with temperature, such as the human body. The pyroelectric sensors are characterized as using small power consumption and having a relatively wide detection range. In this embodiment, the human presence sensors forming the human presence sensor unit 103 will be described as pyroelectric sensors. However, the human presence sensors are not limited to pyroelectric sensors, and may be human presence sensors of a different type. In this embodiment, a human presence array sensor including human presence sensors (pyroelectric sensors) arranged in an N×N array form is used as the human presence sensor unit 103.

The display/operation unit 104 includes a display device (not illustrated) and an input device (not illustrated). The display/operation unit 104 operates under the control of the CPU 105, and displays information received from the CPU 105 via the data bus 109 on the display device (not illustrated). Furthermore, the display/operation unit 104 transmits to the CPU 105 operation information of an operation performed on the input device (not illustrated) by a user.

The CPU 105 controls the whole image processing apparatus 1 by following a program after retrieving the program stored in the HDD 107 onto the memory 106. The memory 106 is a temporary memory to store programs of the CPU 105 retrieved from the HDD 107 and image data. The HDD 107 is a hard disk drive. As well as storing programs of the CPU 105, the HDD 107 also stores data of various screens and various set values which will be described later, image data, and the like. The HDD 107 may also be a flash memory such as a solid state drive (SSD).

The image printing unit 108 operates under the control of the CPU 105, and prints out image data received via the data bus 109 onto printing paper, which is not illustrated, using an electro-photographic process, an inkjet printing method, or the like. The data bus 109 performs transfer of information and image data.

The power control unit 110 supplies power supplied from an external electrical outlet to each processing unit within the image processing apparatus 1. The power control unit 110 includes a power switch 1101 and a power switch 1102. The power switches 1101 and 1102 are switched on or off under the control of the CPU 105. Using these power switches 1101 and 1102, it is possible for the image processing apparatus 1 under the control of the CPU 105 to shift between a plurality of operation modes with different power consumptions.

For example, there are three types of operation modes. The first type of operation mode is a “normal operation mode” (first power status), in which all the functions on the image processing apparatus 1 operate. The normal operation mode is an operation mode in which the CPU 105 controls the power control unit 110 to switch both the power switches 1101 and 1102 on.

The second type of operation mode is a “sleep mode” (second power status), in which power supplies are cut off towards the image reading unit 101, the display/operation unit 104, the HDD 107, and the image printing unit 108. The sleep mode is an operation mode in which the CPU 105 controls the power control unit 110 to switch both the power switches 1101 and 1102 off.

The third type of operation mode is an “only-operation-unit operation mode” (third power status), in which power supplies are cut off towards the image reading unit 101 and the image printing unit 108. The only-operation-unit operation mode is an operation mode in which the CPU 105 controls the power control unit 110 to switch the power switch 1101 on and the power switch 1102 off.

The CPU 105, the memory 106, the network interface unit 102, the human presence sensor unit 103, and the power control unit 110 are constantly supplied with power. The CPU 105 controls the transitions between the above-mentioned three operation modes which have different power consumptions. The transition from the “sleep mode” to the “only-operation-unit operation mode” or to the “normal operation mode” is performed by the CPU 105, using detection information on each sensor of the human presence sensor unit 103, according to the settings which will be described later.

Fundamentally, even during the sleep mode when power supply to the image printing unit 108 and so on is limited, power is supplied to the human presence sensor unit 103. Therefore, when a human presence sensor detects the presence of a person, the CPU 105 is shifted to the normal operation mode and performs control to start power supply to the image printing unit 108 and so on. The transition from the sleep mode to a different operation mode is referred to as a recovery-from-sleep operation.

FIG. 11 is a block diagram of an example of the configuration of the terminal apparatus 2. The terminal apparatus 2, for example, is an information processing apparatus, such as a personal computer. The terminal apparatus 2 may be, for example, a mobile terminal such as a laptop computer, a tablet computer, or a smartphone.

The terminal apparatus 2 as illustrated in FIG. 11, includes a network interface unit 201, a display/operation unit 202, a CPU 203, a memory 204, an HDD 205, and a data bus 206.

The network interface unit 201 operates under the control of the CPU 203, reads data stored in the memory 204 via the data bus 206, and transmits the data to a LAN, which is an external component of the terminal apparatus 2. Furthermore, the network interface unit 201 stores the data received from the external component of the terminal apparatus 2; LAN, in the memory 204 via the data bus 206. For example, the terminal apparatus 2 is capable of communicating with the image processing apparatus 1 illustrated in FIG. 10, via the network interface unit 201.

The display/operation unit 202 operates under the control of the CPU 203, and displays information received from the CPU 203 via the data bus 206 on a display device (display), which is not illustrated. Furthermore, the display/operation unit 202 transmits to the CPU 203 operation information of an operation performed on an input device (for example, a keyboard, a pointing device, or a touch panel), which is not illustrated, by a user.

The CPU 203 controls the whole terminal apparatus 2 by following a program after retrieving the program stored in the HDD 205 onto the memory 204. The memory 204 is a temporary memory to store data received from the LAN, or programs of the CPU 203 retrieved from the HDD 205. The HDD 205 is a hard disk drive. As well as storing programs of the CPU 203, the HDD 205 also stores various data. The HDD 205 may also be a flash memory such as an SSD. The data bus 206 performs data transmission.

The terminal apparatus 2 is capable of performing a remote operation of the image processing apparatus 1 by communicating with the image processing apparatus 1 via the LAN under the control of the CPU 203. Here, the remote operation is, to operate the image processing apparatus 1 from the terminal apparatus 2, by displaying information received from the image processing apparatus 1 on the display/operation unit 202, and by transmitting the operation contents input on the display/operation unit 202 to the image processing apparatus 1.

The remote operation is realized by the control of the CPU 105 of the image processing apparatus 1 and the control of the CPU 203 of the terminal apparatus 2 both working together, and the procedures are as follows.

The CPU 203 of the terminal apparatus 2 transmits a remote operation connection request signal to the image processing apparatus 1 which is connected to the LAN, via the network interface unit 201. The CPU 105 of the image processing apparatus 1 receives the remote operation connection request signal sent from the terminal apparatus 2 via the network interface unit 102. The CPU 105 transmits information required for display of a remote operation and the operation to the terminal apparatus 2 which is connected to the LAN, via the network interface unit 102. The CPU 203 of the terminal apparatus 2 receives the information required for the display of the remote operation and the operation via the network interface unit 201. The CPU 203 of the terminal apparatus 2 displays an operation screen on the display/operation unit 202 on the basis of the information required for the display of the remote operation and the operation, so that an operation from a user can be received. Upon receiving an operation from a user, the CPU 203 of the terminal apparatus 2 transmits a signal indicating the operation contents by the user for the display/operation unit 202 to the image processing apparatus 1 which is connected to the LAN, via the network interface unit 201. The CPU 105 of the image processing apparatus 1 receives the signal transmitted from the terminal apparatus 2 via the network interface unit 102. The CPU 105 of the image processing apparatus 1 and the CPU 203 of the terminal apparatus 2 realize a remote operation by repeating the exchange of information via the LAN, as described above.

FIGS. 3A, 3C, and 3E are schematic diagrams each illustrating the positional relationship between the image processing apparatus 1 and surrounding user(s), and FIGS. 3B, 3D, and 3F are schematic diagrams each illustrating the detection range of a human presence sensor unit 103. FIGS. 3A to 3E are expressed as bird's-eye views looking down on the image processing apparatus 1 and its surrounding from above. The same reference signs are assigned to the same portions as those in FIGS. 1 and 2.

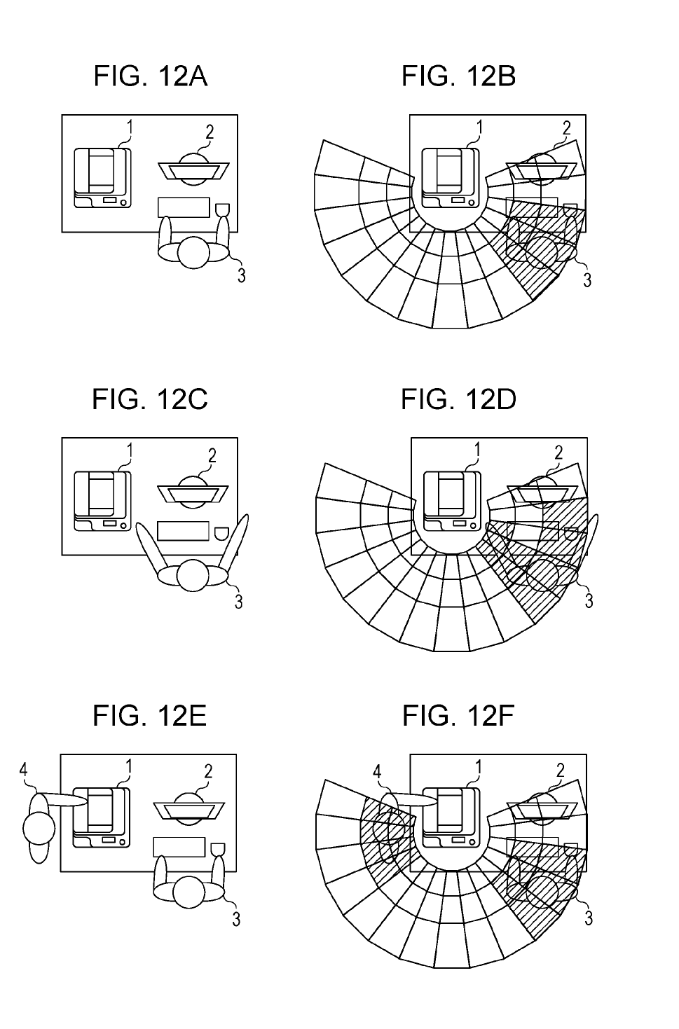

FIG. 12A illustrates the positional relationship between the image processing apparatus 1 and a user 3 who is using the terminal apparatus 2.

FIG. 12B is an illustration of the human presence detection range of the human presence sensor unit 103 in the status illustrated in FIG. 12A, expressed in a plurality of trapezoids. Each trapezoid illustrates the detection range of a corresponding one of the plurality of pyroelectric sensors of the human presence sensor unit 103.

The plurality of pyroelectric sensors of the human presence sensor unit 103, as illustrated in FIG. 12B, are attached diagonally downward around the image processing apparatus 1 in order to detect different ranges, each in close proximity. Oblique-lined trapezoids in FIG. 12B represent that pyroelectric sensors corresponding to the trapezoids are detecting a user.

FIG. 12C illustrates the positional relationship between the image processing apparatus 1 and the user 3 who is using the terminal apparatus 2.

FIG. 12D is an illustration of the human presence detection range of the human presence sensor unit 103 in the status illustrated in FIG. 12C, expressed in a plurality of trapezoids.

FIG. 12E illustrates the positional relationship between the image processing apparatus 1, the user 3 who is using the terminal apparatus 2, and another user 4.

FIG. 12F is an illustration of the human presence detection range of the human presence sensor unit 103 in the status illustrated in FIG. 12E, expressed in a plurality of trapezoids.

The user 3 is not the user who is using the image processing apparatus 1. Therefore, even when the user 3 is detected by the human presence sensor unit 103 in the case where the image processing apparatus 1 is in the sleep mode, the recovery-from-sleep operation is not necessarily performed.

Furthermore, the user 4 is merely there to collect printed paper. However, in the case where the image processing apparatus 1 is in the sleep mode, it is thought that convenience increases when a print situation is displayed on the display device of the display/operation unit 104. Therefore, in the case where the human presence sensor unit 103 detects the user 4, it is preferable that the image processing apparatus 1 performs the recovery-from-sleep operation only on the operation unit.

In this embodiment, the human presence detection range of the human presence sensor unit 103 is illustrated in the plurality of trapezoids. However, the human presence detection range may be illustrated in shapes other than trapezoids, as long as the shapes are equivalent to the shapes of detection ranges of the human presence sensors.

FIGS. 4A to 4F are diagrams each illustrating an example of a screen displayed on the display/operation unit 202 when a remote operation is performed on the image processing apparatus 1 using the terminal apparatus 2.

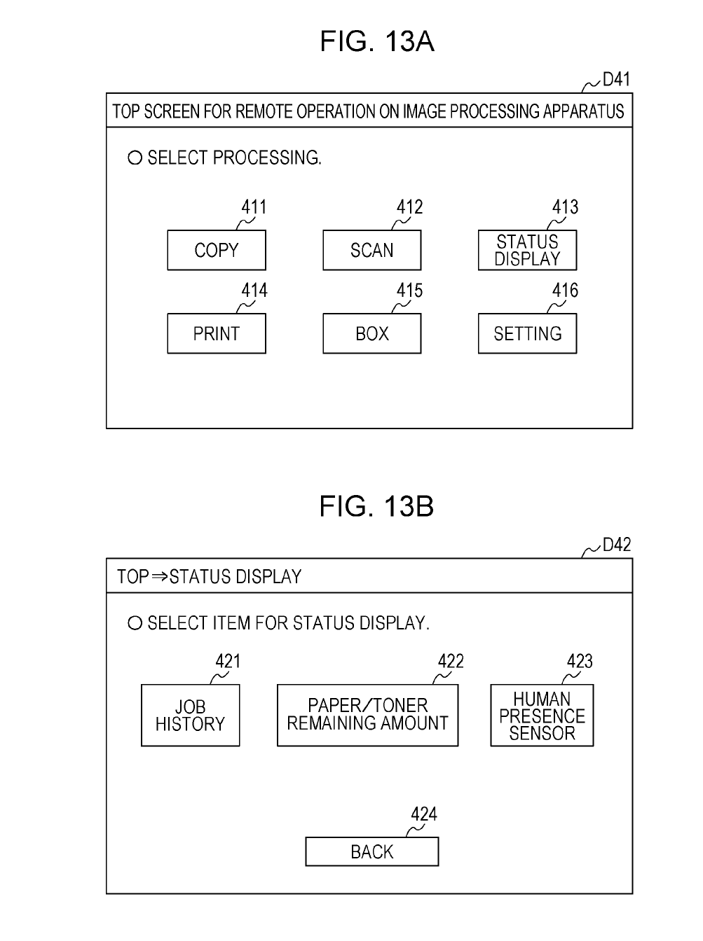

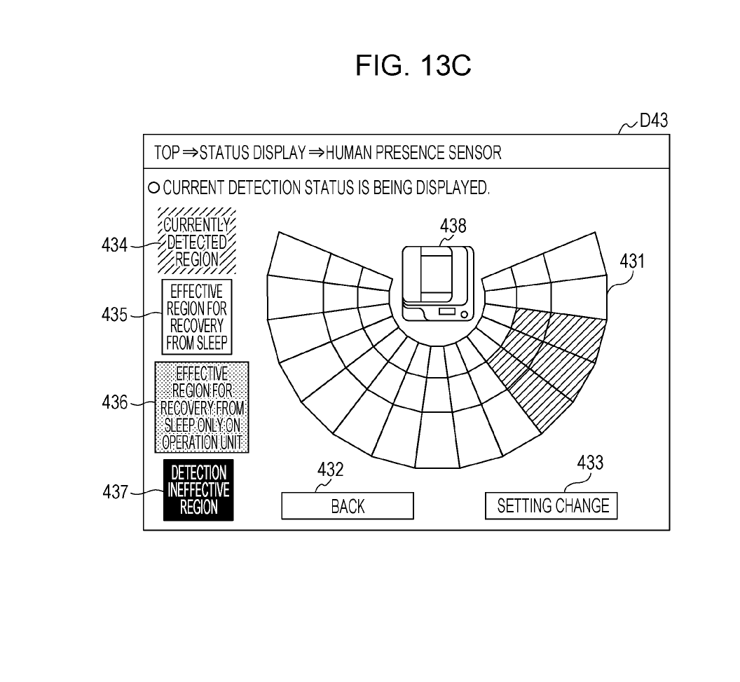

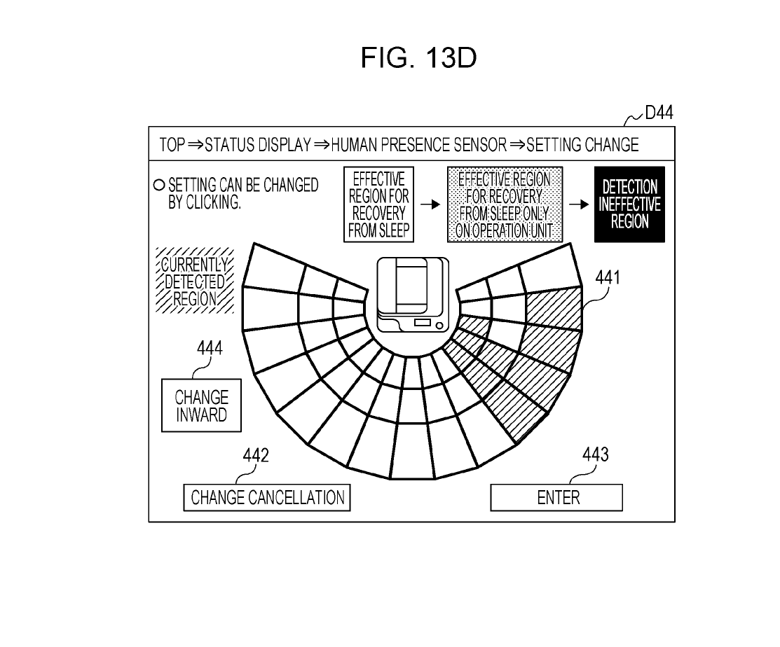

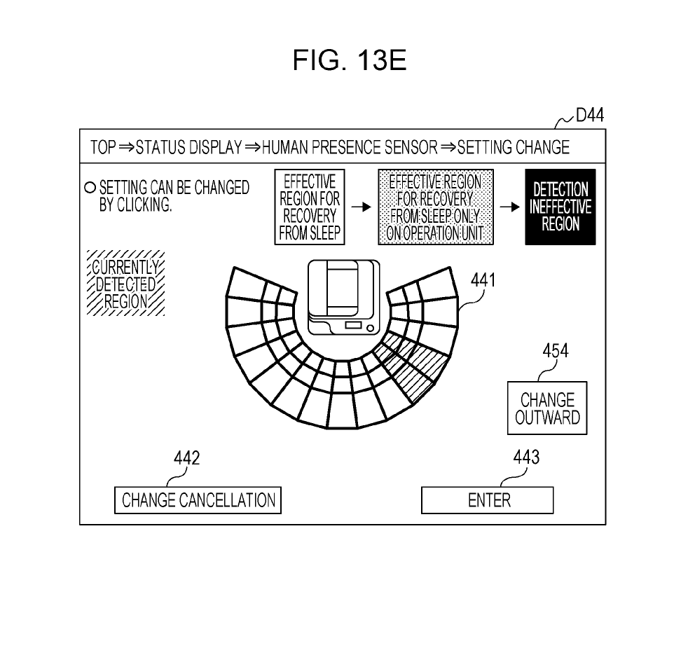

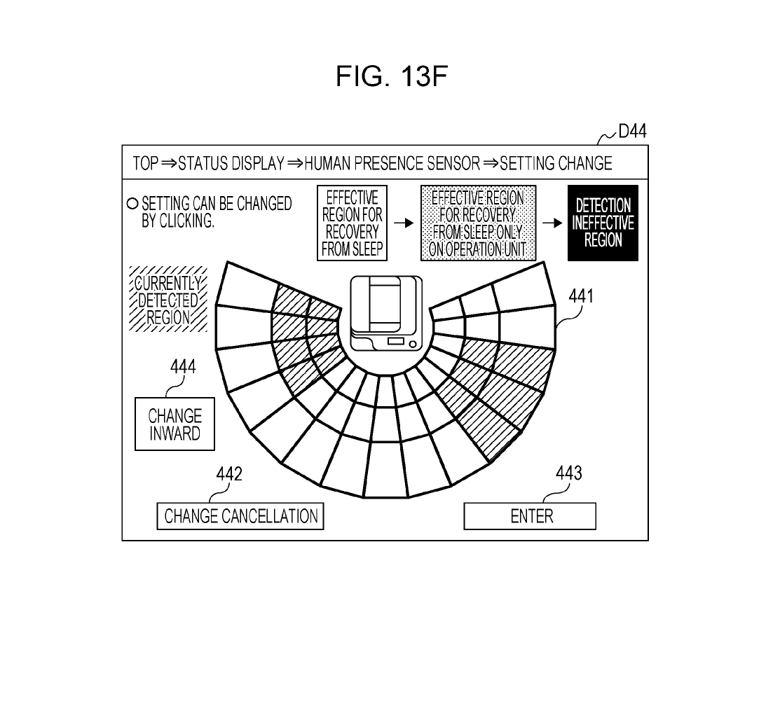

FIG. 13A is an illustration of a top screen D41 on the terminal apparatus 2 when a remote operating application on the image processing apparatus 1 starts. A copy button 411, a scan button 412, a status display button 413, a print button 414, a box button 415, and a setting button 416 are arranged on the top screen D41. The user is able to issue instructions for various operations for the image processing apparatus 1 by clicking (may be instructions by touching or the like, however, hereinafter, “click” will be used) on these buttons.

FIG. 13B is an illustration of a status display screen D42, which appears when the user clicks on the status display button 413 on the top screen D41 (of FIG. 13A). A job history button 421, a paper/toner remaining amount button 422, a human presence sensor button 423, and a back button 424 are arranged on the status display screen D42. The user is able to issue instructions for various operations for the image processing apparatus 1 by clicking on these buttons.

FIG. 13C is an illustration of a human presence sensor screen D43, which appears when the user clicks on the human presence sensor button 423 on the status display screen D42 (of FIG. 13B). Human presence detection ranges 431 of the human presence sensor unit 103, a back button 432, and a setting change button 433 are arranged on the human presence sensor screen D43.

The human presence detection ranges 431 are displayed in such a manner that the relative positions of the human presence detection ranges 431 can be clearly indicated, with reference to a schematic diagram obtained when the image processing apparatus 1 (reference numeral 438 in FIG. 13C), which is illustrated at the center of FIG. 13C, is viewed from above. Furthermore, the human presence detection ranges 431 are expressed as trapezoids. Each trapezoid illustrates the detection range of a corresponding one of the plurality of pyroelectric sensors of the human presence sensor unit 103. For example, each pyroelectric sensor of the human presence sensor unit 103 and each trapezoid have one-to-one correspondence. The position and size of each trapezoid represent the position and size of the detection range of a corresponding pyroelectric sensor on the basis of the relative position from the image processing apparatus 1. In FIG. 13C, oblique-lined trapezoids 434 represent that pyroelectric sensors corresponding to the trapezoids are detecting a user.

Furthermore, each trapezoid holds setting information indicating which recovery-from-sleep operation is performed when a pyroelectric sensor corresponding to the trapezoid detects a user, and the background of the trapezoid is expressed in a pattern (435, 436, 437, etc.) corresponding to the setting information.

The background of a trapezoid holding a setting (first operation setting) for performing an operation (first operation) of changing from the sleep mode to the normal operation mode is expressed in white (white background 435). The background of a trapezoid holding a setting (second operation setting) for performing an operation (second operation) of changing from the sleep mode to the only-operation-unit operation mode is expressed in mesh (meshed background 436). The background of a trapezoid holding a setting (ineffective setting) for not performing a recovery-from-sleep operation even when a user is detected is expressed in black (black background 437). These backgrounds may be expressed in any color as long as they are distinguished from one another.

The setting held by a trapezoid having the white background 435 is referred to as a “recovery-from-sleep effective setting”. The setting held by a trapezoid having the meshed background 436 is referred to as an “only-operation-unit recovery-from-sleep effective setting”. The setting held by a trapezoid having the black background 437 is referred to as a “detection ineffective setting”. The screen D43 (FIG. 13C) corresponds to the case in which the recovery-from-sleep effective setting is set for all the trapezoids (all the trapezoids have the white background 435).

FIG. 13D illustrates a setting change screen D44 appearing when the user clicks on the setting change button 433 on the human presence sensor screen D43 (FIG. 13C).

Human presence detection range buttons 441 of the human presence sensor unit 103, a change cancellation button 442, an enter button 443, and an inward change button 444 are arranged on the setting change screen D44.

Similar to the human presence detection ranges 431 illustrated in FIG. 13C, the human presence detection range buttons 441 are expressed as trapezoids, and the meaning of the oblique lines and background is the same as that of the human presence detection ranges 431. However, the trapezoids of the human presence detection range buttons 441 are buttons. By clicking on a button of each trapezoid, an operation to be performed when a corresponding pyroelectric sensor detects a user can be switched between the recovery-from-sleep effective setting, the only-operation-unit recovery-from-sleep effective setting, and the detection ineffective setting in order. By further clicking on a trapezoid for which the detection ineffective setting has been set, the recovery-from-sleep effective setting can be set for the trapezoid again.

The screen D44 illustrated in FIG. 13D represents the detection status in the situation illustrated in FIGS. 3C and 3D.

FIG. 13E is the setting change screen D44 appearing when the user clicks on the inward change button 444 on the setting change screen D44. The same reference signs are assigned to the same portions as those in FIG. 13D.

When the inward change button 444 (FIG. 13D) is clicked, the CPU 105 of the image processing apparatus 1 changes the directions of the plurality of pyroelectric sensors of the human presence sensor unit 103 slightly downward and reduces the entire detection range inwardly. Along with this operation, the CPU 105 displays the human presence detection range buttons 441 whose size is reduced on the remote operation screen, as illustrated in FIG. 13E.

An outward change button 454 is arranged on the setting change screen D44 illustrated in FIG. 13E. When the outward change button 454 (FIG. 13E) is clicked, the CPU 105 of the image processing apparatus 1 changes the directions of the plurality of pyroelectric sensors of the human presence sensor unit 103 slightly upward and extends the entire detection range outwardly. Along with this operation, the CPU 105 displays the human presence detection range buttons 441 whose size is increased on the remote operation screen.

Although the configuration in which the entire detection range is reduced (increased) inwardly (outwardly) by changing the directions of the plurality of pyroelectric sensors of the human presence sensor unit 103 slightly downward (upward) is illustrated in FIGS. 4A to 4E, the directions of the plurality of pyroelectric sensors of the human presence sensor unit 103 may be capable of being changed to the left and right. With provision of a left change button and a right change button, when the left (right) change button is clicked, the directions of the plurality of pyroelectric sensors of the human presence sensor unit 103 may be changed slightly to the left (right) so that the entire detection range is moved to the left (right). Furthermore, the directions of the plurality of pyroelectric sensors may be capable of being changed in a combination of upward, downward, to the left, and to the right. That is, the directions of the plurality of pyroelectric sensors may be capable of being changed upward in front, downward in front, upward to the left, downward to the left, upward to the right, and downward to the right. Furthermore, the directions of the plurality of pyroelectric sensors of the human presence sensor unit 103 may be capable of being changed toward individual directions in a plurality of stages. That is, the directions of the plurality of pyroelectric sensors of the human presence sensor unit 103 may be capable of being changed in a combination of upward and downward changes in a plurality of stages and changes to the left and to the right in a plurality of stages.

FIG. 13F illustrates the setting change screen D44 appearing when the status around the image processing apparatus 1 has reached the status illustrated in FIGS. 3E and 3F. The same reference signs are assigned to the same portions as those in FIGS. 4D and 4E.

In FIG. 13F, the human presence detection range buttons 441 are trapezoids which have white background and which are provided with oblique lines, and the user 3 and the user 4 illustrated in FIGS. 3E and 3F are being detected. Since a trapezoid having white background is a trapezoid for which recovery-from-sleep effective setting has been set, in the case where the image processing apparatus 1 is in the sleep mode in this status, the image processing apparatus 1 recovers from the sleep mode. That is, in the current setting, a recovery-from-sleep operation which meets the conditions explained above with reference to FIG. 12E that a recovery-from-sleep operation does not need to be performed for the user 3 and that an only-operation-unit recovery-from-sleep operation is preferably performed for the user 4 cannot be performed. Hereinafter, a setting operation for realizing the recovery-from-sleep operation explained above with reference to FIG. 12E will be described.

FIGS. 5A to 5C are diagrams each illustrating an example of a screen displayed on the display/operation unit 202 when a remote operation is performed on the image processing apparatus 1 using the terminal apparatus 2.

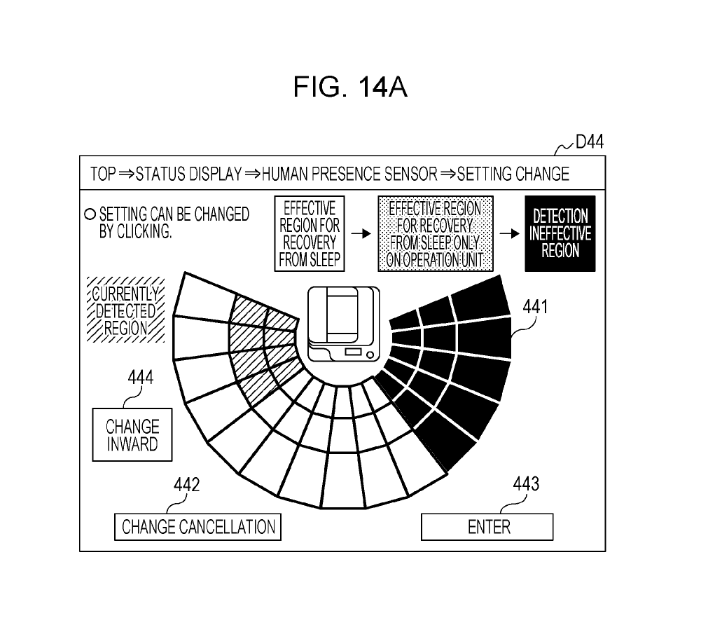

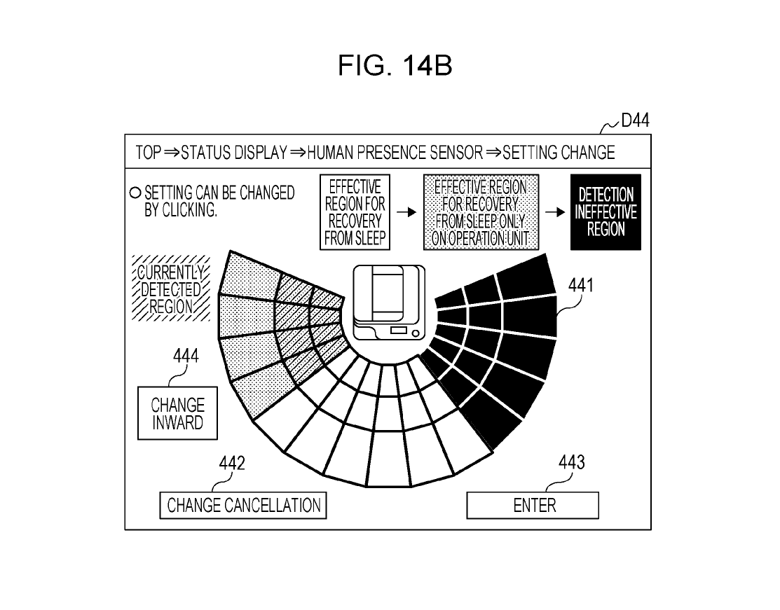

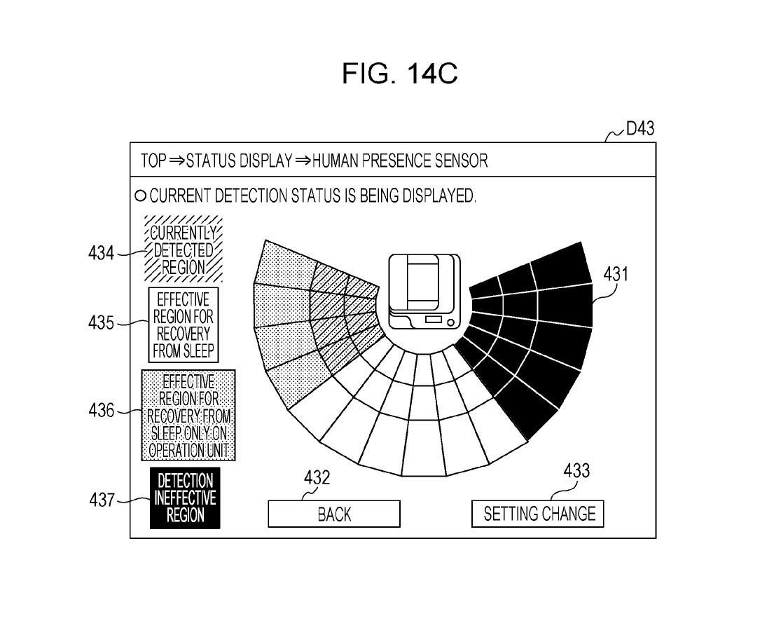

FIG. 14A illustrates the setting change screen D44 appearing by clicking twice on a trapezoidal button corresponding to each pyroelectric sensor that may detect the user 3 illustrated in FIGS. 3E and 3F in the status of the setting change screen D44 illustrated in FIG. 13F so that the trapezoidal button is changed into a trapezoid having black background for which the “detection ineffective setting” is set.

FIG. 14B illustrates the setting change screen D44 appearing by clicking once on a trapezoidal button corresponding to each pyroelectric sensor that may detect the user 4 illustrated in FIGS. 3E and 3F in the status of the setting change screen D44 illustrated in FIG. 14A so that the trapezoid is changed into a trapezoid having meshed background for which the “only-operation-unit recovery-from-sleep setting” is set.

FIG. 14C illustrates the human presence sensor screen D43 appearing by clicking the enter button 443 in the status of the setting change screen D44 illustrated in FIG. 14B so that recovery-from-sleep operation setting of each trapezoid is determined.

On the screen D43 illustrated in FIG. 14C, trapezoids having black background and trapezoids having meshed background, as well as trapezoids having white background, exist. As is clear from this screen, recovery from the sleep mode is not performed in the status in which the user 3 illustrated in FIGS. 3E and 3F is detected. Furthermore, it is clear that recovery from the sleep mode is performed only on the operation unit in the status in which the user 4 illustrated in FIGS. 3E and 3F is detected.

Information on settings of the directions of the plurality of pyroelectric sensors of the human presence sensor unit 103 and the recovery-from-sleep operation setting of each of the plurality of pyroelectric sensors is recorded on the HDD 107 under the control of the CPU 105.

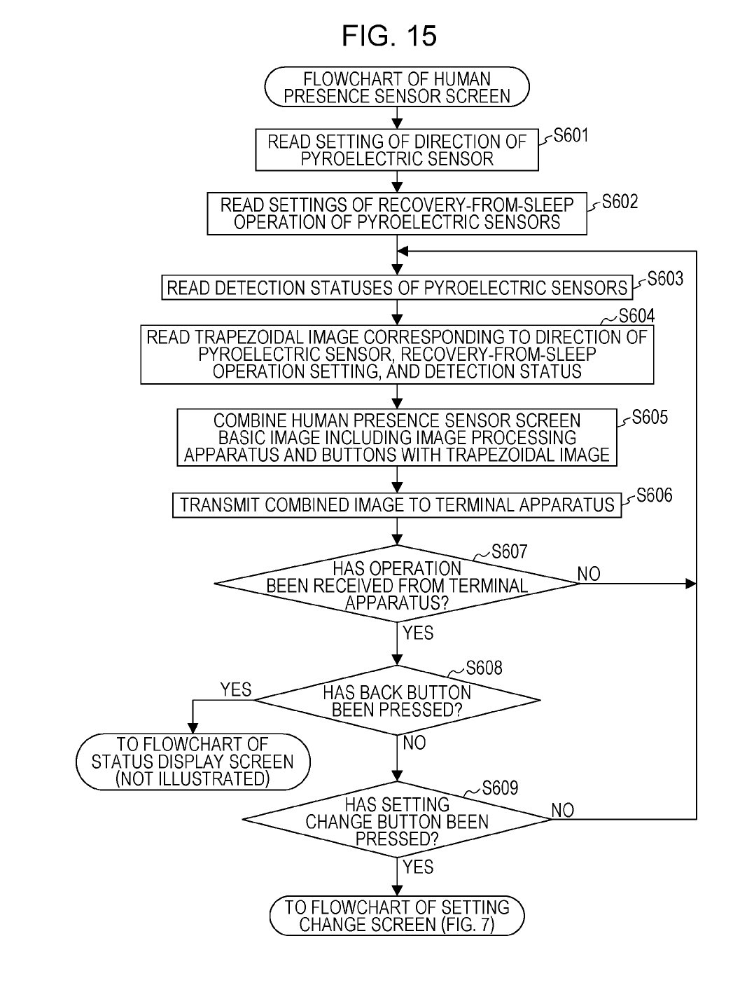

Hereinafter, a flowchart of a human presence sensor screen will be described with reference to FIG. 15.

FIG. 15 is a flowchart of the image processing apparatus 1 on the human presence sensor screen D43 illustrated in FIGS. 4C and 5C. This flowchart represents a process performed by the CPU 105 of the image processing apparatus 1 for generating a human presence sensor screen on which the detection range of each pyroelectric sensor of the human presence sensor unit 103 is expressed as a relative position from the image processing apparatus 1. In FIG. 15, the process includes steps S601 to S609. The process of the flowchart is implemented when the CPU 105 retrieves a computer-readable program recorded on the HDD 107 and executes the program.

When the CPU 105 receives from the terminal apparatus 2 information indicating that the human presence sensor button 423 has been clicked (instructed) on the human presence sensor screen D43 illustrated in FIG. 13B, the process proceeds to step S601 in FIG. 15.

In step S601, the CPU 105 reads setting of directions of the pyroelectric sensors recorded on the HDD 107, and then the process proceeds to step S602.

In step S602, the CPU 105 reads the recovery-from-sleep operation setting of each of the pyroelectric sensors recorded on the HDD 107, and then the process proceeds to step S603.

In step S603, the CPU 105 reads the detection status of each of the pyroelectric sensors from the human presence sensor unit 103, and then the process proceeds to step S604.

In step S604, the CPU 105 reads a trapezoidal image corresponding to a pyroelectric sensor direction, a recovery-from-sleep operation setting, and a detection status from among trapezoidal images recorded on the HDD 107, and then the process proceeds to step S605.

In step S605, the CPU 105 reads a human presence sensor screen basic image including the image processing apparatus and buttons recorded on the HDD 107, and combines the read human presence sensor screen basic image with the trapezoidal image read in step S604 to generate an image. Then, the process proceeds to step S606. The combined image generated in step S605 is display information including information indicating the detection range of the human presence sensor unit 103 as a relative position from the image processing apparatus 1, information indicating, for each region of the human presence sensor unit 103, a region in which a person is being detected and a region in which no person is being detected in such a manner that these regions are distinguished from each other, and information for setting, for each region of the human presence sensor unit 103, an operation performed in the case where the presence of a person is detected.

In step S606, the CPU 105 transmits the combined image generated in step S605 to the terminal apparatus 2 via the network interface unit 102 and the LAN, and then the process proceeds to step S607. Upon receiving the combined image, the terminal apparatus 2 displays the human presence sensor screen D43 illustrated in FIG. 13C on the display/operation unit 202 so that an operation from a user can be received. Upon receiving an operation from the user, the terminal apparatus 2 transmits operation information to the image processing apparatus 1.

In step S607, the CPU 105 of the image processing apparatus 1 determines whether or not the CPU 105 has received the operation information from the terminal apparatus 2.

When it is determined that the CPU 105 has not received the operation information from the terminal apparatus 2 (No in step S607), the CPU 105 returns to step S603.

In contrast, when it is determined that the CPU 105 has received the operation information from the terminal apparatus 2 (Yes in step S607), the CPU 105 proceeds to step S608.

In step S608, the CPU 105 determines whether or not the operation information received in step S607 is clicking on the back button 432.

When it is determined that the operation information is clicking on the back button 432 (Yes in step S608), the CPU 105 proceeds to a flowchart of a status display screen, which is not illustrated.

Although not illustrated, in the flowchart of the status display screen, the CPU 105 reads the status display screen basic image (image illustrated as the status display screen D42 in FIG. 13B) recorded on the HDD 107, and transmits the read status display screen basic image to the terminal apparatus 2 via the network interface unit 102 and the LAN.

Referring back to the flowchart illustrated in FIG. 15, when it is determined in step S608 that the operation information is not clicking on the back button 432 (No in step S608), the CPU 105 proceeds to step S609.

In step S609, the CPU 105 determines whether or not the operation information received in step S607 is clicking on the setting change button 433.

When it is determined that the operation information is not clicking on the setting change button 433 (No in step S609), the CPU 105 returns to step S603.

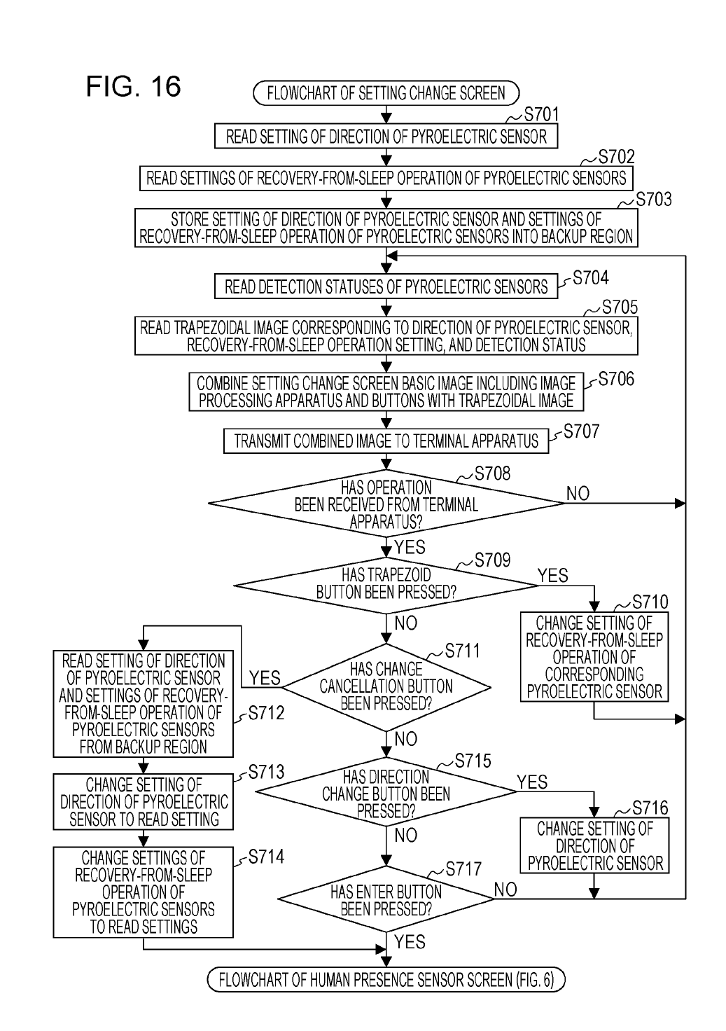

In contrast, when it is determined that the operation information is clicking on the setting change button 433 (Yes in step S609), the CPU 105 proceeds to a flowchart of a setting change screen illustrated in FIG. 16.

A flowchart of a setting change screen will now be explained with reference to FIG. 16.

FIG. 16 is a flowchart of the image processing apparatus 1 on the setting change screen D44 illustrated in FIGS. 4D to 4F and FIGS. 5A to 5B. This flowchart represents a process performed by the CPU 105 of the image processing apparatus 1 for generating the setting change screen D44 and changing the directions of pyroelectric sensors and the recovery-from-sleep operation setting of each of the pyroelectric sensors. In FIG. 16, the process includes steps S701 to S717. The process of this flowchart is implemented when the CPU 105 retrieves a computer-readable program recorded on the HDD 107 and executes the program.

In step S701, the CPU 105 of the image processing apparatus 1 first reads setting of the directions of the pyroelectric sensors recorded on the HDD 107, and the process proceeds to step S702.

In step S702, the CPU 105 reads the recovery-from-sleep operation setting of each of the pyroelectric sensors recorded on the HDD 107, and the process proceeds to step S703.

In step S703, the CPU 105 records the setting of the directions of the pyroelectric sensors read in step S701 and the recovery-from-sleep operation setting of each of the pyroelectric sensors read in step S702 into a region that is different from the original region of the HDD 107, and the process proceeds to step S704. Hereinafter, the original region will be referred to as a setting region, and the different region will be referred to as a backup region.

In step S704, the CPU 105 reads the detection status of each of the pyroelectric sensors from the human presence sensor unit 103, and the process proceeds to step S705.

In step S705, the CPU 105 reads a trapezoidal image corresponding to a pyroelectric sensor direction, a recovery-from-sleep operation setting, and a detection status from among trapezoidal images recorded on the HDD 107. Then, the process proceeds to step S706.

In step S706, the CPU 105 reads a setting change screen basic image including the image processing apparatus and buttons recorded on the HDD 107, and combines the setting change screen basic image with the trapezoidal image read in step S705 to generate an image. Then, the process proceeds to step S707.

In step S707, the CPU 105 transmits the combined image generated in step S706 to the terminal apparatus 2 via the network interface unit 102 and the LAN, and the process proceeds to step S708. Upon receiving the combined image, the terminal apparatus 2 displays the setting change screen D44 illustrated in FIGS. 4D to 4F and FIGS. 5A to 5B so that the terminal apparatus 2 can receive an operation from a user. Upon receiving an operation from the user, the terminal apparatus 2 transmits operation information to the image processing apparatus 1. The terminal apparatus 2 is capable of transmitting, as the operation information, instructions including an instruction for changing the setting of a specific detection range of the human presence sensor unit 103 into the “detection ineffective setting” for causing the detection range of the human presence sensor unit 103 to be ineffective, an instruction for changing the setting of the specific detection range into the “recovery-from-sleep effective setting” for changing from the sleep mode to the normal operation mode, an instruction for changing the setting of the specific detection range into the “only-operation-unit recovery-from-sleep effective setting” for changing only the operation unit from the sleep mode to the operation mode, and an instruction for changing the direction of a pyroelectric sensor of the human presence sensor unit 103.

In step S708, the CPU 105 determines whether or not the CPU 105 has received the operation information from the terminal apparatus 2.

When it is determined that the operation information has not been received from the terminal apparatus 2 (No in step S708), the CPU 105 proceeds to step S704.

When it is determined that the CPU 105 has received the operation information from the terminal apparatus 2 (Yes in step S708), the CPU 105 proceeds to step S709.

In step S709, the CPU 105 determines whether or not the operation information received in step S708 is clicking on a trapezoidal button (human presence detection range button 441).

When it is determined that the operation information is clicking on a trapezoidal button (human presence detection range button 441) (Yes in step S709), the CPU 105 proceeds to step S710.

In step S710, the CPU 105 performs switching of the recovery-from-sleep operation setting of a pyroelectric sensor corresponding to the trapezoidal button (human presence detection range button 441) clicked in step S708, and records the setting to the setting region of the HDD 107. Then, the process returns to step S704. At this time, the CPU 105 controls the switching contents in accordance with the contents of the original recovery-from-sleep operation setting. In the case where the original setting is the “recovery-from-sleep effective setting”, switching to the “only-operation-unit recovery-from-sleep effective setting” is performed. In the case where the original setting is the “only-operation-unit recovery-from-sleep effective setting”, switching to the “detection ineffective setting” is performed. In the case where the original setting is the “detection ineffective setting”, switching to the “recovery-from-sleep effective setting” is performed.

In contrast, when it is determined that the operation information is not clicking on a trapezoidal button (human presence detection range button 441) (No in step S709), the CPU 105 proceeds to step S711.

In step S711, the CPU 105 determines whether or not the operation information received in step S708 is clicking on the change cancellation button 442.

When it is determined that the operation information is clicking on the change cancellation button 442 (Yes in step S711), the CPU 105 proceeds to step S712.

In step S712, the CPU 105 reads from the HDD 107 the setting of the directions of the pyroelectric sensors and the recovery-from-sleep operation setting of each of the pyroelectric sensors recorded in the backup region of the HDD 107 in step S703, and the process proceeds to step S713.

In step S713, the CPU 105 records the setting of the directions of the pyroelectric sensors read in step S712 into the setting region of the HDD 107.

In step S714, the CPU 105 records the recovery-from-sleep operation setting of each of the pyroelectric sensors read in step S712 into the setting region of the HDD 107, and the process proceeds to the flowchart of the human presence sensor screen illustrated in FIG. 15.

When it is determined in step S711 that the operation information is not clicking on the change cancellation button 442 (No in step S711), the CPU 105 proceeds to step S715.

In step S715, the CPU 105 determines whether or not the operation information received in step S708 is clicking on the inward change button 444 or the outward change button 454.

When it is determined that the operation information is clicking on the inward change button 444 or the outward change button 454 (Yes in step S715), the CPU 105 proceeds to step S716.

In step S716, the CPU 105 performs switching of the setting of the directions of the pyroelectric sensors of the human presence sensor unit 103, and records the setting into the setting region of the HDD 107. Then, the process returns to step S704. At this time, the CPU 105 controls the switching contents in accordance with the contents of the original setting of the directions of the pyroelectric sensors. In the case where the original setting is outward setting, switching to inward setting is performed. In the case where the original setting is inward setting, switching to outward setting is performed.

When it is determined in step S715 that the operation information is neither clicking on the inward change button 444 nor clicking on the outward change button 454 (No in step S715), the CPU 105 proceeds to step S717.

In step S717, the CPU 105 determines whether or not the operation information received in step S708 is clicking on the enter button 443.

When it is determined that the operation information is not clicking on the enter button 443 (No in step S717), the CPU 105 proceeds to step S704.

In contrast, when it is determined that the operation information is clicking on the enter button 443 (Yes in step S717), the CPU 105 immediately proceeds to the flowchart of the human presence sensor screen illustrated in FIG. 15.

An example of the operation of the image processing apparatus 1 with the configuration described above according to an embodiment of the present invention will be described below.

This example corresponds to a process performed, by the user 3 who is working near the image processing apparatus 1, for setting the image processing apparatus 1 not to perform a recovery-from-sleep operation even if the image processing apparatus 1 detects the user 3 and for setting the image processing apparatus 1 to enter the only-operation-unit operation mode when the image processing apparatus 1 detects the user 4 who comes near the image processing apparatus 1 to collect printed paper.

First, in the status illustrated in FIG. 12A, in order to start a remote operation of the image processing apparatus 1, the user 3 starts up the terminal apparatus 2. As described above, the terminal apparatus 2 starts communication with the image processing apparatus 1 via the LAN, under the control of the CPU 203. Under the control of the CPU 105, the image processing apparatus 1 performs, in a repetitive manner if necessary during a period in which the remote operation is performed, an operation for transmitting screen information for the remote operation to the terminal apparatus 2, receiving operation information from the terminal apparatus 2, and causing the received operation information to be reflected in internal settings.

The image processing apparatus 1 transmits a screen for a remote operation (top screen D41) to the terminal apparatus 2. The terminal apparatus 2 displays the received top screen D41 on the display device of the display/operation unit 202.

In order to review the status of the human presence sensor unit 103, the user 3 clicks on the status display button 413 on the top screen D41. The terminal apparatus 2 transmits operation information of the user 3 to the image processing apparatus 1. Upon receiving the operation information, the image processing apparatus 1 transmits the status display screen D42 to the terminal apparatus 2. The terminal apparatus 2 displays the received status display screen D42 on the display device of the display/operation unit 202.

In order to review the status of the human presence sensors, the user 3 clicks on the human presence sensor button 423 on the status display screen D42. The terminal apparatus 2 transmits operation information of the user 3 to the image processing apparatus 1. Upon receiving the operation information, the image processing apparatus 1 transmits the human presence sensor screen D43 to the terminal apparatus 2. At this time, as described above, the image processing apparatus 1 generates a schematic diagram in which trapezoids corresponding to pyroelectric sensors (also corresponding to directions of the pyroelectric sensors) are arranged so that the positions of the pyroelectric sensors of the human presence sensor unit 103 are clear from relative positions from the image processing apparatus 1. Furthermore, the image processing apparatus 1 adds the current settings of the pyroelectric sensors to the trapezoids in the schematic diagram as the background of the trapezoids and the current detection statuses of the pyroelectric sensors as oblique lines. The terminal apparatus 2 displays the received human presence sensor screen D43 on the display device of the display/operation unit 202.

By viewing the human presence sensor screen D43, the user 3 is able to understand the human presence detection range of the human presence sensor unit 103 from the relative position from the image processing apparatus 1 and is also able to understand that the user 3 is located within the detection range and is being detected by a pyroelectric sensor. The human presence sensor screen D43 is regularly updated under the control of the CPU 105 of the image processing apparatus 1.

In order to change the setting of the human presence sensor unit 103, the user 3 clicks on the setting change button 433 on the human presence sensor screen D43. The terminal apparatus 2 transmits operation information of the user 3 to the image processing apparatus 1. Upon receiving the operation information, the image processing apparatus 1 transmits the setting change screen D44 (FIG. 13D) to the terminal apparatus 2. At this time, in order to review the maximum range that can be detected when the user 3 moves, the user 3 performs an operation of spreading their arms wide as illustrated in FIG. 12C. The image processing apparatus 1 generates the setting change screen D44 (FIG. 13D) which reflects the change in the current detection status of pyroelectric sensors. The terminal apparatus 2 displays the received setting change screen D44 (FIG. 13D) on the display device of the display/operation unit 202. The setting change screen D44 is regularly updated under the control of the CPU 105 of the image processing apparatus 1.

By viewing the setting change screen D44 illustrated in FIG. 13D, the user 3 is able to understand the maximum range that can be detected when they move. In order to change the directions of sensors of the human presence sensor unit 103, the user 3 clicks on the inward change button 444. The terminal apparatus 2 transmits operation information of the user 3 to the image processing apparatus 1.

Upon receiving the operation information, the image processing apparatus 1 changes the directions of the pyroelectric sensors of the human presence sensor unit 103 more downward, generates the setting change screen D44 (FIG. 13E) which reflects the human presence detection range and the human presence detection status with the changed directions, and transmits the setting change screen D44 to the terminal apparatus 2. The terminal apparatus 2 displays the received setting change screen D44 (FIG. 13E) on the display device of the display/operation unit 202. That is, when the directions of the pyroelectric sensors of the human presence sensor unit 103 are changed, the setting change screen D44 is updated under the control of the CPU 105 of the image processing apparatus 1.

By viewing the setting change screen D44 illustrated in FIG. 13E, the user 3 is able to understand that the detection range of the human presence sensor unit 103 is narrowed and the user 3 continues to be detected even after the directions of the sensors of the human presence sensor unit 103 are changed. In order to recover the original directions of the human presence sensors, the user 3 clicks on the outward change button 454. The terminal apparatus 2 transmits operation information of the user 3 to the image processing apparatus 1.

Upon receiving the operation information, the image processing apparatus 1 changes the directions of the pyroelectric sensors of the human presence sensor unit 103 more upward, generates the setting change screen D44 which reflects the human presence detection range and the human presence detection status with the changed direction, and transmits the generated setting change screen D44 to the terminal apparatus 2. At this time, the user 3 returns their arms to the original position, and the different user 4 is approaching the image processing apparatus 1 as illustrated in FIG. 12E. The image processing apparatus 1 generates the setting change screen D44 (FIG. 13F) which reflects the change in the current detection status of the pyroelectric sensors. The terminal apparatus 2 displays the received setting change screen D44 (FIG. 13F) on the display device of the display/operation unit 202.

By viewing the setting change screen D44 illustrated in FIG. 13F, the user 3 is able to understand that the user 4 who comes near the image processing apparatus 1 to collect printed paper is being detected by the human presence sensor unit 103. In order to perform setting for not performing a recovery-from-sleep operation based on detection by the human presence sensor unit 103 around the user 3, the user 3 clicks twice on the trapezoids (human presence detection range buttons 441) corresponding to the position of the user 3, the corresponding trapezoids being determined by the foregoing processing, and the surrounding trapezoids (human presence detection range buttons 441). The terminal apparatus 2 transmits operation information of the user 3 to the image processing apparatus 1. Upon receiving the operation information, the image processing apparatus 1 changes setting information regarding the recovery-from-sleep operation for the clicked trapezoids, and generates the setting change screen D44 (FIG. 14A) including trapezoids having background corresponding to the new setting information. The terminal apparatus 2 displays the received setting change screen D44 (FIG. 14A) on the display device of the display/operation unit 202. That is, when the recovery-from-sleep setting of the pyroelectric sensors of the human presence sensor unit 103 is changed, the setting change screen D44 is updated under the control of the CPU 105 of the image processing apparatus 1.

By viewing the setting change screen D44 illustrated in FIG. 14A, the user 3 is able to understand that setting for not performing a recovery-from-sleep operation based on the detection by human presence sensors is set around the user 3. Then, in order to perform setting for shifting to the only-operation-unit operation mode when the user 4 who comes near the image processing apparatus 1 to collect printed paper is detected, the user 3 clicks once on trapezoids (human presence detection range buttons 441) corresponding to the current position of the user 4 and trapezoids (human presence detection range buttons 441) corresponding to the route through which the user 4 travels to the current position. The terminal apparatus 2 transmits operation information of the user 3 to the image processing apparatus 1. Upon receiving the operation information, the image processing apparatus 1 changes setting information regarding the recovery-from-sleep operation on the clicked trapezoids, generates the setting change screen D44 (FIG. 14B) including trapezoids having background corresponding to the new setting information, and transmits the generated setting change screen D44 to the terminal apparatus 2. The terminal apparatus 2 displays the received setting change screen D44 (FIG. 14B) on the display device of the display/operation unit 202.

By viewing the setting change screen D44 illustrated in FIG. 14B, the user 3 is able to understand that setting for shifting to the only-operation-unit operation mode based on the detection by the human presence sensors has been set for the position of the user 4. The user 3 confirms that desired settings have been set for the human presence sensors, and clicks on the enter button 443 in order to determine the settings. The terminal apparatus 2 transmits operation information of the user 3 to the image processing apparatus 1. Upon receiving the operation information, the image processing apparatus 1 transmits the human presence sensor screen D43 (FIG. 14C) to the terminal apparatus 2. The terminal apparatus 2 displays the received human presence sensor screen D43 (FIG. 14C) on the display device of the display/operation unit 202.

As described above, the user 3 is able to understand whether the recovery-from-sleep operation by the human presence sensor unit 103 matches an intention of the user 3 while reviewing the detection range of the human presence sensor unit 103 on the basis of the relative position from the image processing apparatus 1 by a remote operation using the terminal apparatus 2.

Furthermore, by moving to a position at which the user 3 wants to be detected and to a position at which the user 3 does not want to be detected and, especially, performs an operation of spreading their arms wide, the user 3 is able to understand whether the position is included in an expected detection range. For example, in the case where a mobile terminal, such as a laptop PC, a tablet PC, or a smartphone, is used as the terminal apparatus 2, the user is able to perform setting of the direction of the human presence sensor unit 103 and recovery-from-sleep operation setting while carrying the mobile terminal and moving around the image processing apparatus 1. By performing settings as described above, settings of the human presence sensor unit 103 can be performed so that the image processing apparatus 1 is capable of operating as intended by the user 3 more reliably. The settings of the human presence sensor unit 103 may also be performed using the display/operation unit 104. In particular, in the case where the display/operation unit 104 is removable from the image processing apparatus 1, the display/operation unit 104 achieves effects similar to those effects of the above-mentioned portable terminal.

Furthermore, by setting the details of a recovery-from-sleep operation based on detection by the human presence sensor unit 103, an instruction for causing a human presence sensor to be effective or ineffective can be provided. Furthermore, an instruction for an operation performed when a human presence sensor detects a person can be provided. Thus, the user can easily perform adjustment to a detection range as desired. Although the configuration including the “only-operation-unit recovery-from-sleep effective setting” is provided has been explained in this embodiment, a different setting for causing a specific portion of the image processing apparatus 1, instead of the operation unit, to recover from the sleep mode when a specific human presence sensor detects a person may be provided. For example, setting for causing the display/operation unit 104 and the image reading unit 101 to recover from the sleep mode in the case where a specific human presence sensor detects a person, may be provided.

When the directions of the plurality of human presence sensors of the human presence sensor unit 103 are changed, the recovery-from-sleep operation setting of the human presence sensors may be reset or may be maintained. For example, the image processing apparatus 1 is configured such that in the case where the recovery-from-sleep operation setting of each human presence sensor can be maintained for each direction of the human presence sensor, when the direction of the human presence sensor is changed, the recovery-from-sleep operation setting of the human presence sensor corresponding to the direction is made effective. In the case of this setting, when the direction of a human presence sensor is returned to the original direction, the recovery-from-sleep operation setting of the human presence sensor is also returned to the original setting with the changed direction.

Furthermore, the image processing apparatus 1 is configured such that the setting of the direction of a human presence sensor and the recovery-from-sleep operation setting of the human presence sensor are held independently of each other and that even when the direction of the human presence sensor is changed, the recovery-from-sleep operation setting of the human presence sensor is equal to the original setting before the direction is changed.

Furthermore, the sensitivity of each human presence sensor of the human presence sensor unit 103 may be changeable.

As described above, according to an embodiment the present invention, since the detection range of a human presence sensor can be reviewed from a relative position from the image processing apparatus, a user is able to notice that a control operation using the human presence sensor does not match a user's intention.

Furthermore, since the current response status of a human presence sensor can be viewed on the remote operation unit, by moving to a position at which the user wants to be detected or a position at which the user does not want to be detected and viewing the remote operation unit, the user is able to understand whether the position is inside or outside a detection range expected by the user.

Furthermore, since the user is able to designate effectiveness or ineffectiveness of a human presence sensor and recovery-from-sleep operation setting, such as setting for causing only the operation unit to recover from the sleep mode, by operating the remote operation unit on the spot, the user can easily perform adjustment to an expected detection range.

Regarding review of the detection range of a human presence sensor, for example, a method for causing a light-emitting diode (LED) provided in the image processing apparatus to be turned on when the human presence sensor unit 103 detects a person so that the user can recognize that the user is being detected, is possible. However, in this method, since it is unclear which human presence sensor of the human presence sensor unit 103 is detecting a person or it is difficult to identify which human presence sensor of the human presence sensor unit 103 is detecting a person, this method is not very effective. In contrast, according to an embodiment of the present invention, the user is able to clearly understand which human presence sensor is detecting the user on the remote operation unit. Therefore, the user is able to perform setting of human presence sensors reliably.

Thus, the user can visually understand the detection range of a human presence sensor easily, and can easily change the direction of the human presence sensor and the operation setting in the case where a person is detected. Thus, a desired control can be performed in a more reliable manner such that the presence of a user is detected and the apparatus recovers from the sleep mode when the user who intends to use an apparatus comes near the apparatus, and in contrast, that detection of a person who just passes by the apparatus is suppressed and the apparatus remains in the sleep mode.

As described above, according an embodiment of the present invention, by understanding the detection range of a human presence sensor on the basis of a relative position from the image processing apparatus, the user is able to recognize that a control operation using the human presence sensor enters a state which does not match a user's intention, adjust the detection range of the human presence sensor to an appropriate state, and cause the control operation using the human presence sensor to be adjusted to match the status intended by the user.

As described above, by displaying the detection range of a human presence sensor on a remote user interface (UI) so as to allow the user to understand the detection range on the basis of a relative position from the apparatus body so that the user can perform setting on the spot, the user can easily review and adjust an invisible detection range of a human presence sensor.

Although a technique according to the present invention is used for power control of the image processing apparatus in the embodiment described above, the technique may be used for power control of different electronic equipment.

For example, the technique may be used for information processing apparatuses (for example, an information processing apparatus for providing information installed in a lounge in a company, a sightseeing area, etc.) for presenting information to a visitor by displaying content appropriate for the visitor. Such an information processing apparatus may be controlled such that, when a visitor is detected, the information processing apparatus recovers from a sleep status to a normal status so that specific content (guidance, sightseeing information, etc.) is displayed. Regarding the detection range of a human presence sensor, problems similar to those described above in a related art may exist. With application of the present invention to such an information processing apparatus, by understanding the detection range of a human presence sensor on the basis of a relative position from the information processing apparatus, a user is able to recognize that a control operation using the human presence sensor enters a status which does not match a user's intention. Thus, the user is able to adjust the detection range of the human presence sensor to an appropriate status, and the control operation using the human presence sensor can be adjusted to a status intended by the user. Furthermore, such an information processing apparatus may be configured such that the information processing apparatus recovers from the sleep mode and processing up to content display is performed in the case where the information processing apparatus detects a person in a specific region (in front of the apparatus etc.), whereas only recovery from the sleep mode is performed in the case where a person is detected in a different region (at a position on a side of the apparatus etc.).

Furthermore, the present invention may be applied to cameras. In this case, such a camera may be configured such that the camera recovers from the sleep mode and performs processing up to photographing and recording in the case where a person in a specific region (for example, a region that needs to be monitored) is detected by a sensor provided in the camera, whereas the camera performs only recovery from the sleep mode in the case where a person in a different region is detected.

Furthermore, the present invention may also be applicable to household electrical appliances, such as air-conditioning apparatuses, television equipment, and lighting equipment, that detect a person and perform various operations.

Obviously, various data described above do not necessarily have the configuration and contents described above and may have various configurations and contents according to uses and purposes.

Although an embodiment of the present invention has been described above, the present invention may include an embodiment as, for example, a system, an apparatus, a method, a program, or a storage medium. More specifically, the present invention may be applied to a system including a plurality of devices or may be applied to an apparatus including a single device.

Furthermore, all the configurations of combinations of the foregoing embodiments may be included in the present invention.

### Other Embodiments

The present invention may also be practiced by performing a process as described below. That is, software (program) that realizes one or more functions according to any embodiment described above may be supplied to a system or an apparatus via a network or a storage medium, and a computer (or CPU, MPU, or the like) in the system or the apparatus may read out the supplied software and execute it.

Note that the invention may be applied to a system including a plurality of devices or to an apparatus including only a single device.

The present invention is not limited to the embodiments described above, but various modifications and changes (including various organic combinations of embodiments) may be possible without departing from the spirit of the invention. Note that all such modifications and changes also fall in the scope of the invention. That is, any combination of arbitrary embodiments or modifications falls within the scope of the present invention.

Thus, as described above, the present invention provides a benefit that it is possible to control the image processing apparatus so as to be properly maintained in the power saving state without being unnecessarily returned into the normal state from the power saving state even in an installation environment in which the detection area includes a desk, a passage, or the like where a non-user person/object that does not use the image processing apparatus is detected frequently.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-264254 filed Dec. 3, 2012 and No. 2012-264536 filed Dec. 3, 2012, which are hereby incorporated by reference herein in their entirety.

What is claimed is:

1. An image processing apparatus having a first electric power state and a second electric power state in which less electric power is consumed than in the first electric power state, comprising:
a detection unit including a plurality of detector elements capable of detecting an object;
a registration unit configured to register a detector element in the plurality of the detector elements as an invalid detector element that is to be neglected; and
an electric power control unit configured to turn the image processing apparatus into the first electric power state or the second electric power state according to a detection state of a detector element other than the detector element registered as the invalid detector element by the registration unit.

2. The image processing apparatus according to claim 1, wherein in a case where a detection state of a detector element other than the detector element registered as the invalid detector element by the registration unit turns from a none-detected state into an object-detected state, the electric power control unit turns the image processing unit from the second electric power state into the first electric power state.

3. The image processing apparatus according to claim 1, wherein in a case where a detection state of a detector element other than the detector element registered as the invalid detector element by the registration unit turns from an object-detected state into a none-detected state, the electric power control unit turns the image processing unit from the first electric power state into the second electric power state.

4. The image processing apparatus according to claim 1, wherein the registration unit performs the registration in terms of the invalid detector element according to a user operation accepted via an operation unit.

5. The image processing apparatus according to claim 1, wherein in a case where the image processing apparatus is not used over a period with a predetermined length of time after the image processing apparatus is turned from the second electric power state into the first electric power state in response to detecting an object by a particular detector element in the plurality of detector elements, the registration unit registers the particular detector element as an invalid detector element which is to be neglected.

6. The image processing apparatus according to claim 1, wherein each detector element is an infrared photosensor configured to sense an infrared ray.

7. The image processing apparatus according to claim 1, wherein each detector element is a pyroelectric sensor.

8. The image processing apparatus according to claim 1, wherein the detection unit is a line sensor in which the plurality of detector elements are arranged in a line or an array sensor in which the plurality of sensor elements are arranged in the form of a matrix.

9. A method of controlling an image processing apparatus including a detection unit including a plurality of detector elements and having a first electric power state and a second electric power state in which less electric power is consumed than in the first electric power state, comprising:
registering a detector element in the plurality of detector elements as an invalid detector element that is to be neglected; and
turning the image processing apparatus into the first electric power state or the second electric power state according to a detection state of a detector element other than the detector element registered as the invalid detector element by the registration unit.
